(19) United States
(12) Patent Application Publication
(10) Pub. No.: US 2014/0210796 A1
(43) Pub. Date: Jul. 31, 2014

(54) SYSTEM AND METHOD FOR DETECTING AND LOCATING A DISTURBANCE IN A MEDIUM

(71) Applicants: Jean-Pierre Nikolovski, Carry-le-Rouet (FR); Nicolas Guenard, Chatou (FR); Gerard Chalubert, Voisins Le Bretonneux (FR)

(72) Inventors: Jean-Pierre Nikolovski, Carry-le-Rouet (FR); Nicolas Guenard, Chatou (FR); Gerard Chalubert, Voisins Le Bretonneux (FR)

(73) Assignee: Commissariat a l'energie atomique et aux ene alt, Paris (FR)

(21) Appl. No.: 14/235,702

(22) PCT Filed: Jul. 9, 2012
(86) PCT No.: PCT/FR2012/051615

§ 371 Date: Jan. 28, 2014

(30) Foreign Application Priority Data
Jul. 28, 2011 (FR) 1156892

(51) Int. Cl. G06F 3/043

(52) U.S. Cl. CPC G06F 3/043
USPC 345/177

(57) ABSTRACT

A system for detecting and locating a disturbance of a medium includes a medium for propagating bulk acoustic waves, a mechanism for emitting bulk acoustic waves in the medium, a mechanism for receiving the bulk acoustic waves after propagation thereof in the medium, configured to supply a reception signal from the acoustic waves received, and a mechanism for detecting and locating the disturbance in the medium from the reception signal. The medium includes a dermis layer of elastic material with a thickness locally deformable by the disturbance.

The present invention concerns a system for detecting and locating a disturbance in a medium. It also concerns a method used by this system.

Various systems for detecting and locating a disturbance in a medium, comprising a medium for propagating bulk acoustic waves, means of transmitting bulk acoustic waves in the medium, means of receiving bulk acoustic waves after propagation thereof in the medium, designed to supply a reception signal from the acoustic waves received, and means of detecting and locating the disturbance in the medium from the reception signal, are known from the prior art.

The patent published under the number U.S. Pat. No. 6,741,237 describes a system using the disturbance of a transit time for seismic acoustic waves propagating in an object, for example a touch screen, between an emitting transducer and at least two receiving transducers disposed around the object so that this disturbance generates different fluctuations in the transit times from the disturbance zone to the two receiving transducers. This system is solely based on differences in transit time and requires placing the transducers at precise points around the object in order to maximise the differentials in transit time in at least two distinct directions, for example in the corners for a rectangular touch-screen plate. In addition, it makes it possible to detect a disturbance of the touch type at one point, but not to characterise it further.

The patent published under the number FR 2 916 545 describes a system using a relative absorption signature recognition of a seismic acoustic wave on a set of resonance figures of the interface object. The relative damping and phase difference for each frequency caused by a touch constitutes one of the components of a relative damping vector constructed on a predefined number of resonance figures. By means of this system, it is possible to detect and locate precisely an interaction on any three-dimensional surface using a small number of transducers, at a measurement rate that may be as much as fifty locations per second. Nevertheless, this system has the drawback of being limited to a function of detecting a single touch and location of this touch without being able to characterise it or interpret it more precisely.

An improvement to this system is proposed in the French patent application published under the number FR 2 948 471, wherein they are no longer resonance figures but transient radiation figures, normally referred to as “diffraction pulse figures” that are used. Thus the location method used is not dependent on the eigenfrequencies of the object and is moreover capable of detecting multiple touches. However, there also, the detection system does not make it possible to characterise or interpret this single or multiple touch more precisely.

It may thus be wished to provide a system for detecting and locating a disturbance of a medium that makes it possible to dispense with at least some of the aforementioned problems and constraints.

The subject matter of the invention is therefore a system for detecting and locating a disturbance of a medium, comprising:
a medium for propagating bulk acoustic waves,
means of emitting bulk acoustic waves in the medium,
means of receiving the bulk acoustic waves after propagation thereof in the medium, designed to provide a reception signal from the acoustic waves received, and
means of detecting and locating the disturbance in the medium from the reception signal,
   wherein the medium comprises a so-called dermis layer of elastic material with a thickness locally deformable by the disturbance.

By virtue of this invention, the sensitivity of the medium to any disturbance is increased by the elasticity of its dermis in terms of thickness. In particular not only does the analysis of the reception signal make it possible to detect the disturbance and to locate it, but also it makes it possible, because of a local deformation caused by the disturbance in the thickness of the dermis and a substantial influence of this local deformation on the reception signal, to characterise it more finely. It is thus possible to envisage for example differentiating a touch from a caress or a more violent blow, by combining location and detection of deformation in terms of thickness.

Optionally, the Young's modulus characteristic of the elasticity of the dermis is between 0.1 and 10 Mpa.

Optionally also, the dermis consists of a polymer, gel or silicone resin and has a thickness at rest of between 0.5 and 5 mm, preferably 2 mm.

Optionally also, the bulk acoustic waves emitted in the medium comprise pressure waves propagating in the dermis.

Optionally also, the medium comprises a supplementary layer, referred to as the epidermis, tensioned against the external surface of the dermis and with a texture such that a contact with friction on this epidermis generates a spectrum of acoustic vibrations in audible frequencies detected by the means of receiving bulk acoustic waves.

Optionally also, the dermis layer is disposed in a recess in a rigid support of the system and protected by a cover, for example made from plastics or metal material, with lateral dimensions less than those of the recess for insertion thereof in the latter and partial immersion thereof in the dermis.

Optionally also, a system for detecting and locating a disturbance in a medium according to the invention may comprises a vibrating device embedded in the dermis for a vibrotactile feedback controlled according to mechanical vibrations with a frequency less than 500 Hz in the dermis, preferably even less than 200 Hz.

Optionally also:
the means of emitting bulk acoustic waves comprise at least one resonating disc emitting in a predetermined emission frequency range, outside the audible frequency range from 50 Hz to 15 kHz, and
the means of receiving bulk acoustic waves comprise at least one resonating disc for receiving in a frequency range including at least the predetermined emission frequency range and the audible frequency range.

Optionally also, the predetermined emission frequency range is included in the range 20 kHz-100 kHz.

Optionally also, a system for detecting and locating a disturbance in a medium according to the invention may comprise means of estimating a detected disturbance duration and means of measuring a heat transfer from or to the propagation medium during this disturbance duration.

Optionally also, a system for detecting and locating a disturbance in a medium according to the invention may further comprise means of slaving the temperature of at least part of the propagation medium to at least one predetermined slaving temperature and means of estimating the effusivity of a disturbing object from this slaving temperature and the heat transfer measurement.

Optionally also, a system for detecting and locating a disturbance in a medium according to the invention may comprise means of measuring a damping, due to the presence of a disturbance, of the bulk acoustic waves propagating in the medium and means of estimating the contact surface area of this disturbance from the damping measurement.

Optionally also:
the emission means are means of emitting successive acoustic waves in the medium,
the reception means are means of receiving the successive acoustic waves after propagation thereof in the medium, and
the emission means are designed such that, the amplitude and/or phase spectrum of each acoustic wave having, at at least a certain frequency, an amplitude and/or respectively a phase varying in the medium according to a certain spatial amplitude and/or respectively phase distribution, these spatial amplitude and/or respectively phase distributions of the successive acoustic waves being different from each other.

The invention will be better understood by means of the following description, given solely by way of example and made with reference to the accompanying drawings, in which:

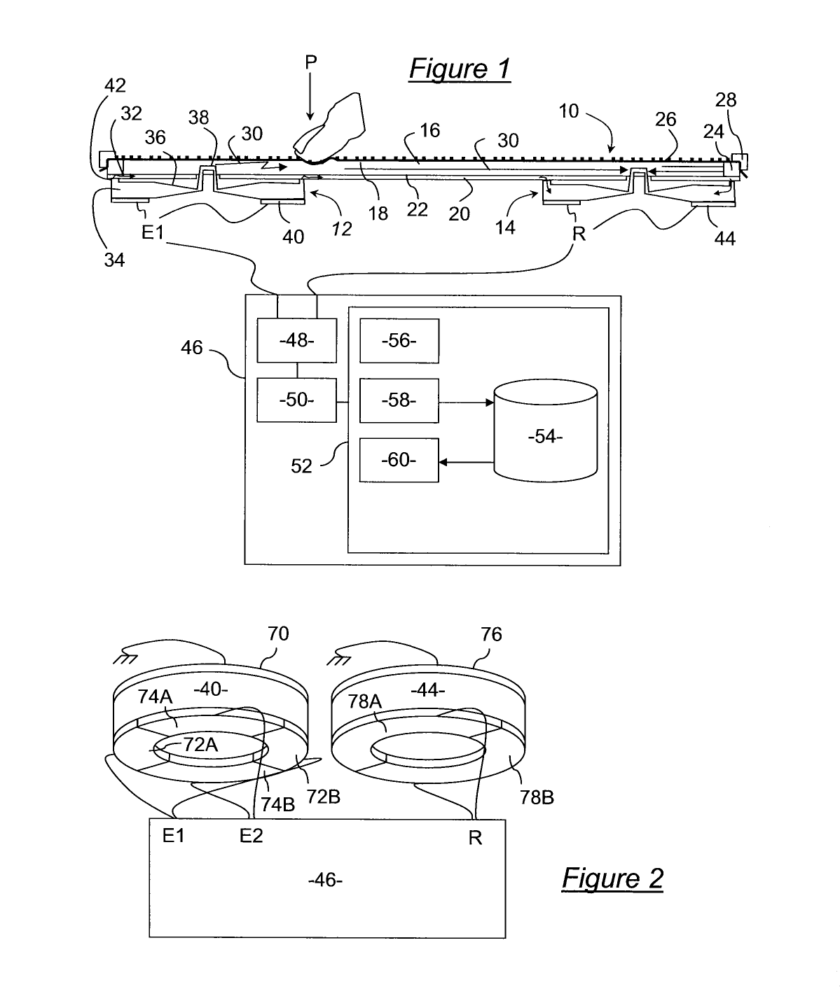

FIG. 1 shows schematically and in section the general structure of a detection and location system according to one embodiment of the invention,

FIG. 2 illustrates more precisely acoustic emission and reception means of the system of FIG. 1,

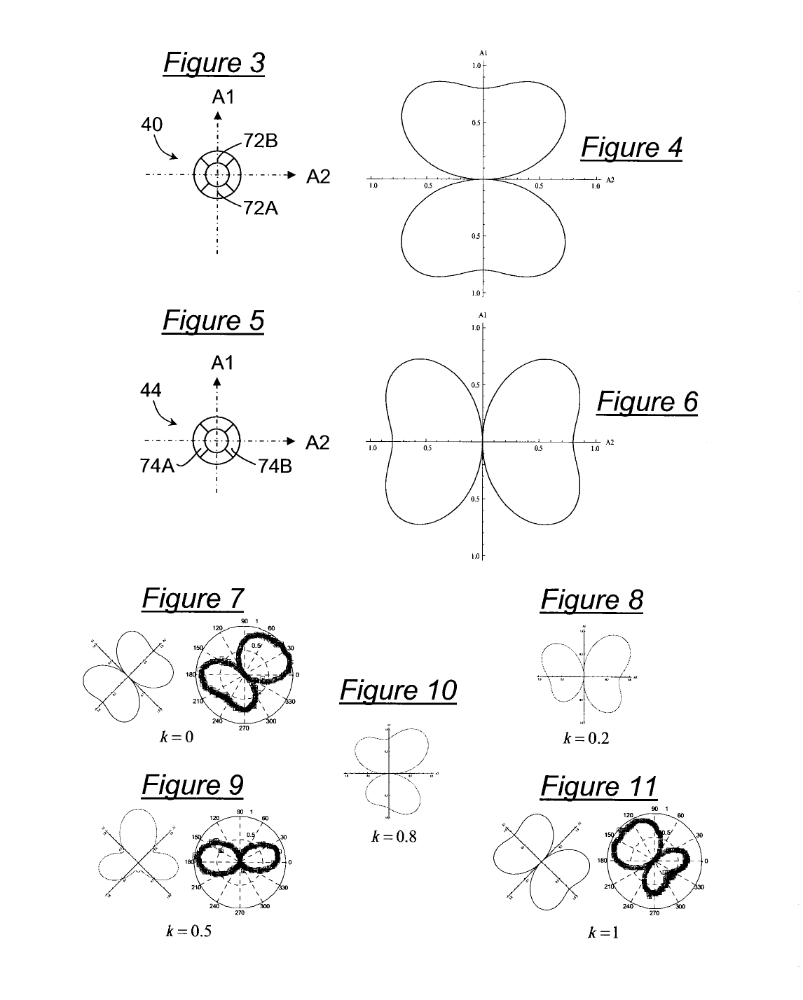

FIG. 3 is a view from below of the emission means of FIG. 2, on which a first acoustic wave source is indicated,

FIG. 4 is a directivity diagram of the first acoustic wave source of FIG. 3,

FIG. 5 is a view from below of the emission means of FIG. 2, on which a second acoustic wave source is indicated,

FIG. 6 is a directivity diagram of the second acoustic wave source of FIG. 5,

FIGS. 7 to 11 are theoretical and experimental directivity diagrams of the emission means of FIG. 2 according to various relative contributions of the two acoustic wave sources in FIGS. 3 and 5,

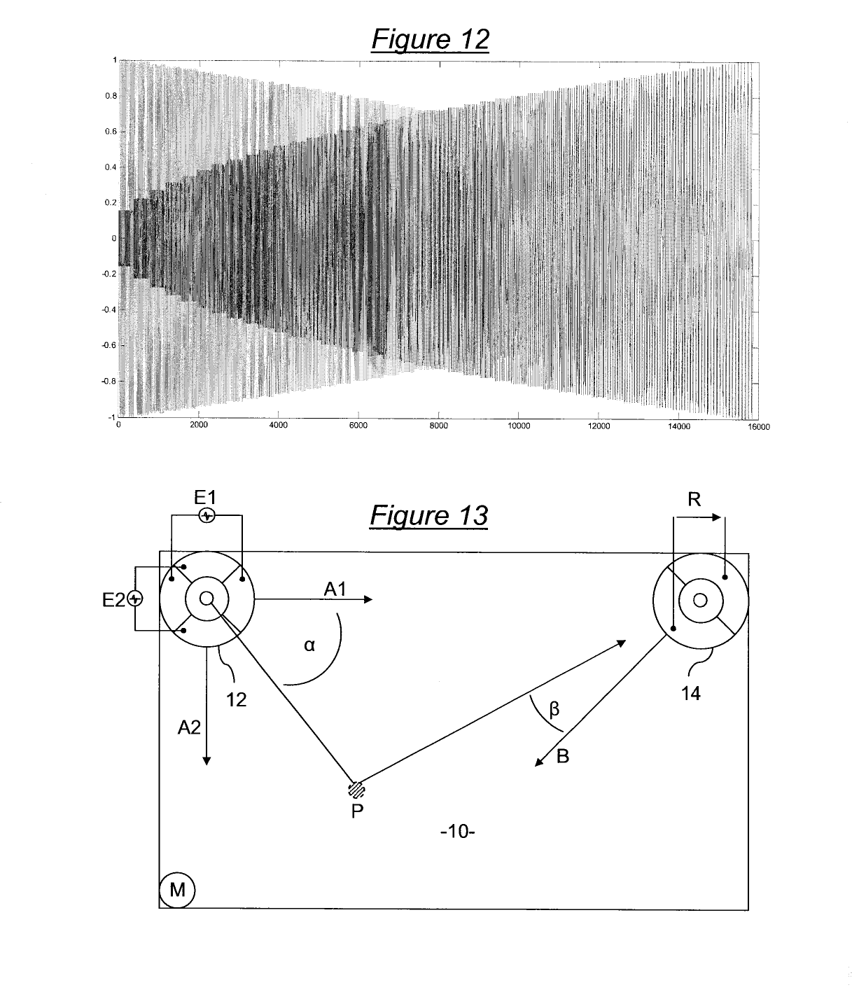

FIG. 12 is a graph illustrating two control signals supplied by a data-processing device respectively to the two acoustic wave sources of the emission means of FIG. 2,

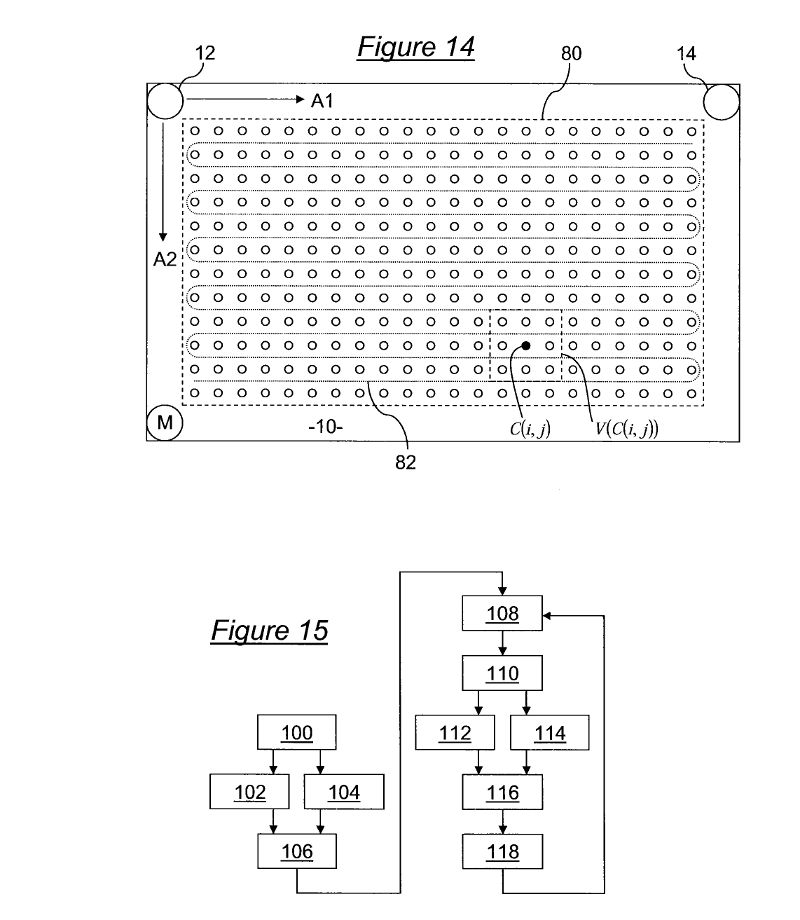

FIGS. 13 and 14 show schematically and partially the system of FIG. 1 in a view from below,

FIG. 15 illustrates the successive steps of a learning method used by the system of FIG. 1,

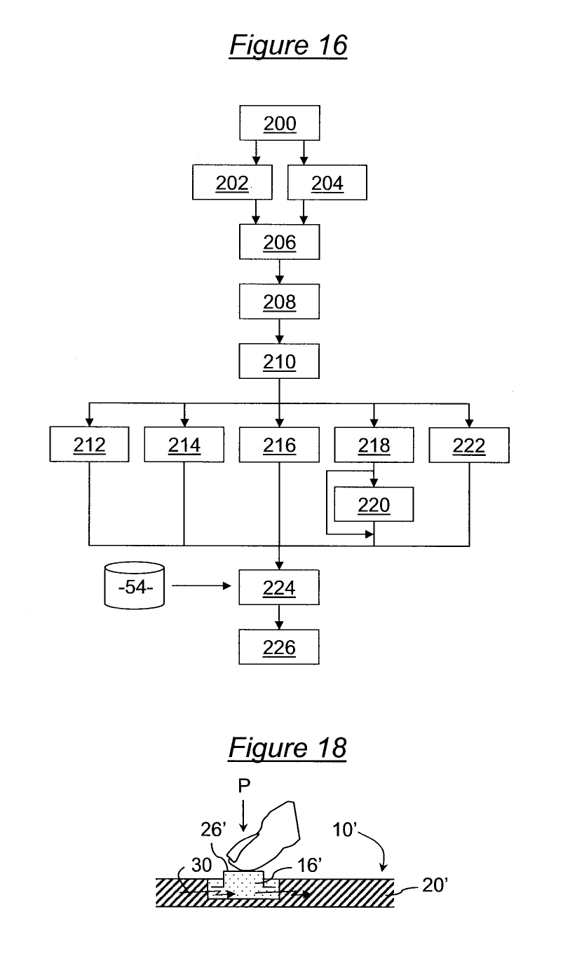

FIG. 16 illustrates the successive steps of a method of detecting, locating and characterising disturbances used by the system of FIG. 1,

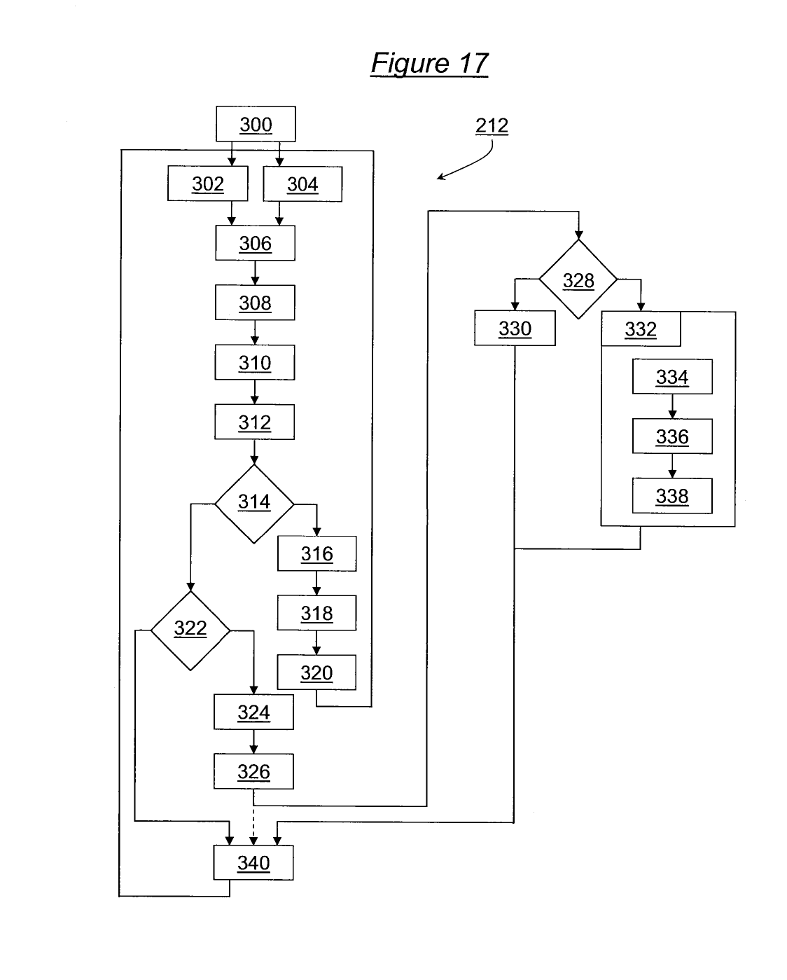

FIG. 17 details a monitoring step of the method of FIG. 15, and

FIG. 18 shows schematically, partially and in section, the structure of a detection and location system according to another embodiment of the invention.

The system for detecting and locating a disturbance P illustrated schematically in section in FIG. 1 comprises a medium 10 for propagating bulk acoustic waves forming a man-machine touch interface, more precisely a touch surface. It further comprises means 12 of emitting bulk acoustic waves in the medium 10, designed to emit these bulk acoustic waves on reception of at least one control signal (E1 in FIG. 1) and means 14 of receiving the bulk acoustic waves after propagation thereof in the medium 10, designed to supply a reception signal R from the acoustic waves received. Finally, it comprises means of detecting and locating the disturbance P in the medium 10 from the reception signal R.

The medium 10 for propagating bulk acoustic waves is illustrated in FIG. 1 as being flat, for example roughly rectangular in shape, and with a very fine thickness compared with its lateral dimensions. However, it could in more general terms be any shape in three-dimensional space. In practice, it may be an interactive interface of the screen type (in this case, it is rather flat) but also a humanoid robot or toy shell for example (in this case, the medium 10 is three-dimensional in form reproducing, with regard to the robot, the form of a body part interacting with the outside: head, hand, etc. of the robot).

It comprises mainly a so-called dermis layer 16, of elastic material with a thickness locally deformable by a disturbance of its external surface 18, in particular the disturbance P. The thickness of the dermis 16 at rest, that is to say when it is not subjected to any disturbance, is for example between 0.5 and 5 mm, preferably between 1 and 3 mm, preferably even equal to 2 mm+/−10%. It is chosen from an elastic material the Young's modulus of which is preferably between 0.5 and 10 MPa, such as in particular a polymer, a silicone gel, a silicone resin or a viscous liquid. Thus, for example, for a thickness of 2 mm and a Young's modulus of 0.1 MPa, the dermis 16 may have its thickness decreased locally by 10% to 40% when a pressure of 1 N/cm² is applied thereto. Finally, according to the application in question, the material of the dermis may be chosen indifferently so as to be opaque or transparent.

One material that may be suitable for forming the dermis 16 is for example a silicone gel having the following properties:
scale G Rockwell hardness: 120,
low viscosity: 450 MPa·s at 23° C.,
stable and flexible from −50° C. to +200° C.,
self-amalgamating gel,
density: 0.97,
thermal expansion coefficient: 9.6 10⁻⁴/° C.,
resistivity: 3.10¹⁵ ohms·cm,
polymerisation: 4 hours at 65° C., 1 hour at 100° C., 15 minutes at 150° C.

The dermis 16 may be tensioned in a rigid frame thus constituting a tensioned flat interface, but it is preferably, as illustrated in FIG. 1, closely coupled, for example following an operation of pouring or dipping in a polymer resin bath, to a plate 20 or more generally a carrier structure that may be a thin rigid three-dimensional shell, made from glass, plastics material or metal, itself fixed to a frame or support at a limited number of fixed points, such as the plastic protective shells of humanoid robots or touch tablets and screens. The coupling with the plate 20 extends over the entire internal surface 22, opposite to the external surface 18, of the dermis 16.

So as to delimit the surface occupied by the dermis 16 in FIG. 1, an internal frame 24 with the same thickness as the dermis 16 is fixed to the periphery of the plate 20 and surrounds the latter. The internal frame 24 also fulfils a function of reflector for acoustic waves propagating in the dermis 16.

Optionally, an additional layer 26, referred to as the epidermis, appreciably thinner than the dermis 16, is tensioned against the external surface 18 thereof. This epidermis 26 consists for example of a flexible sheet or a textured plastic film, such as PVC or vinyl, with a thickness of between 0.05 and 0.5 mm, preferably between 0.1 and 0.3 mm, preferably even 0.2 mm+/−10%. It is tensioned against the dermis 16 and crushed between the internal frame 24 and an external frame 28 fitting on top. A first function fulfilled by this epidermis 26 is to protect the dermis 16 against surface attacks. A second function is to reduce the friction forces facilitating any sliding, relating to an exploration or caress for example, on the surface of the propagation medium 10. Finally, a third function is to generate, in the case of contact with friction, by virtue of its texture and tribological characteristics, an acoustic vibration spectrum in audible frequencies, in particular below 5 kHz. This audible spectrum is moreover discriminating since it makes it possible to distinguish for example a caress from a scraping and stabilises the sliding during a caress, which also stabilises the acoustic damping level of the underlying waves implemented by a contact with the whole surface of a hand.

The propagation medium 10 thus consisting of the plate 20, the dermis 16 and the epidermis 26 can be obtained by plastic injection, which makes it simple to manufacture.

The emission means 12 are designed for the emission of bulk acoustic waves 30, 32, among which some are longitudinal or pressure waves 30 propagating throughout the thickness of the dermis 16 and others are bending waves 32 propagating throughout the thickness of the plate 20 (or more generally of the support for the dermis 16). The propagation of acoustic waves in the epidermis 26 is negligible because of the relative thinness of this supplementary layer with respect to the other two. In fact, apart from its aforementioned three main functions, the epidermis 26 fulfils a function of acoustic insulation for maintaining the propagation of the waves emitted by the emission means 12 in the propagation medium 10.

More precisely, the emission means 12 take the form of a resonating disc, for example made from metal, having a periphery 34 and a central part 36 thinning from the periphery towards the centre of the disc, as far as a central opening. The emission resonating disc 12 also comprises a hollow central sleeve 38 extending in the dermis 16 perpendicular to the disc from the periphery of the central opening, through an opening formed in the plate 20. The periphery 34 of the emission resonating disc 12 has a bottom face (directed in the opposite direction to the plate 20) covered with a piezoelectric ring 40 the structure of which will be detailed with reference to FIG. 2. It also has a top face (directed towards the plate 20) comprising a peripheral rib 42 bonded to the plate 20 for the transmission of the bending waves 32 in the latter. Thus the bulk acoustic waves generated by the piezoelectric ring 40 are transmitted by the emission resonating disc 12 to the dermis 16 by means of the central sleeve 38 and the plate 20 by virtue of the peripheral rib 42.

Preferably, the emission resonating disc 12 is designed so that the proportion of waves emitted in the dermis 16 is appreciably greater than those emitted in the plate 20. The solid-solid coupling between the emission resonating disc 12 and the plate 20 being more effective than the solid-elastic medium transmission between the emission resonating disc 12 and the dermis 16, contact through the peripheral rib 42 suffices. Obviously, any other type of low-coupling contact could also be suitable. This configuration has, in any event, the advantage of allowing a fixing of the emission resonating disc 12 by bonding against the plate 20.

The emission resonating disc has a diameter from 10 to 20 mm and the central sleeve 38 passes through the plate 20 without touching it, emerging in the dermis 16 in order to rise from the plate 20 by a height preferentially of around half the thickness of the dermis 16. It is closed on the side emerging in the dermis 16.

The reception means 14 are designed for the reception of the bulk acoustic waves 30, 32 being propagated in the propagation medium 10, including the longitudinal or pressure waves 30 being propagated in the dermis 16 and the bending waves 32 being propagated in the thickness of the plate 20.

More precisely, the reception means 14 take the form of a resonating disc similar to the emission resonating disc 12, with the exception of the bottom face of the periphery thereof, which is covered with a piezoelectric ring 44 different from the piezoelectric ring 40. A non-limitative example of a structure for this piezoelectric ring 44 will be detailed with reference to FIG. 2, but it should be noted that, for optimisation of the reception of the waves emitted in the propagation medium 10, the reception resonating disc 14 preferably supplies a differential signal issuing from two half-rings so that its reception spectrum is broader than the emission spectrum of the resonating disc 12. Thus it is capable of detecting not only disturbances, referred to as active disturbances, detectable in the frequency band of the acoustic waves emitted by the emission resonating disc 12, but also disturbances, referred to as passive disturbances (since they do not require an emission activated by the resonating disc 12), detectable outside this frequency band. In particular, if an ultrasonic emission frequency band is chosen between 20 kHz and 100 kHz, the reception resonating disc 14 is judiciously designed to detect also audible acoustic waves (with frequencies between 50 Hz and 15 kHz). Advantage may therefore be taken of the texture of the epidermis 26, able to generate audible acoustic waves specific to certain types of disturbance: caress, scraping, etc.

The reception resonating disc 14 is also fixed by bonding it peripheral rib against the plate 20 so that the emission and reception means are in direct coupling via the plate. This coupling is therefore stable and independent of any other support device.

The detection and location means are used in a computing device 46 connected to the emission 12 and reception 14 resonating discs. This computer device 46 is designed to receive and process the reception signal R. It is also designed to supply the control signal or signals (E1 in FIG. 1) to the emission resonating disc 12. For this purpose, it is designed to implement actions that will be detailed with reference to FIGS. 15 to 17.

The computing device 46 comprises for example a conventional computer comprising an input/output interface 48, and a processor 50 associated with one or more memories identified by the generic reference 52. The memory 52 stores a reference database 54, some data of which are determined by learning for the detection, location and qualification of disturbances.

The memory 52 also stores one or more computer programs 56, 58, 60 consisting of sequences of instructions making it possible, when they are executed by the processor 50, to perform the following actions:
emitting acoustic waves in the propagation medium 10 (program 56),
executing a learning for the detection, location and qualification of disturbances on the epidermis 26 (program 58),
detecting, locating and qualifying disturbances of the epidermis 26 by processing the reception signal R (program 60).

It should also be noted that the computer programs 56, 58, 60 are presented as distinct, but this distinction is purely functional. They could just as well be grouped together in one or more sets of software. The functions thereof could also be at least partly microprogrammed or microwired in dedicated integrated circuits. Thus, in a variant, the computing device 46 could be replaced by an electronic device composed solely of electronic circuits (without computer program) for performing the same actions. Moreover, given that the reception signal R is analogue at the output of the reception resonating disc 14, it could undergo some of its processing operations before digitisation, such as for example filterings and amplifications.

With reference to FIG. 2, the piezoelectric ring 40 of the emission resonating disc 12 has a top face covered with a top electrode 70 by means of which it is bonded to the bottom face of the periphery 34 of the emission resonating disc 12. The piezoelectric ring 40 also has a bottom face covered with four bottom electrodes 72A, 72B and 74A, 74B each covering a quarter of this annular bottom face. In the example described, the piezoelectric ring 40 is biased uniformly over its entire surface.

The piezoelectric ring 44 of the reception resonating disc 14 likewise has a top face covered with a top electrode 76 by means of which it is bonded to the bottom face of the periphery of the reception resonating disc 14. The piezoelectric ring 44 also has a bottom face covered with two bottom electrodes 78A, 78B each covering half of this annular bottom face. In the example described, the piezoelectric ring 44 is also biased uniformly over its entire surface.

The top electrodes 70 and 76 of the two piezoelectric rings 40 and 44 are connected to an electrical earth of the computing device 46. In addition, the computing device 46 is designed to supply the following control signals to the emission resonating disc 12:
a first control signal E1=e₁(t) between the two opposite bottom electrodes 72A, 72B, and
a second control signal E2=e₂(t) between the two opposite bottom electrodes 74A, 74B.

Finally, it is designed to receive the reception signal R=r(t) between the two opposite bottom electrodes 78A, 78B from the acoustic waves received by the reception resonating disc 14.

In the example described, the two opposite bottom electrodes 72A and 72B are more precisely biased between respectively two potentials opposite to each other:

$$- \frac{{e}_{1} ( t )}{2} and + \frac{{e}_{1} ( t )}{2} .$$

Likewise, the two opposite bottom electrodes 74A and 74B are more precisely biased between respectively two potentials opposite to each other:

$$- \frac{{e}_{2} ( t )}{2} and + \frac{{e}_{2} ( t )}{2} .$$

Finally, the two opposite bottom electrodes 78A and 78B arrive at the inputs of a differential amplifier and are more precisely biased between respectively two potentials opposite to each other:

$$- \frac{r ( t )}{2} and + \frac{r ( t )}{2} .$$

A method of emitting acoustic waves in the propagation medium 10, for the detection and location of disturbances, implemented by the program 56, will now be detailed. It is necessary first to define the concepts of radiation diagram and directivity that will be used hereinafter.

A radiation diagram of an acoustic wave source corresponds to the amplitude modulus of the acoustic waves at each point on a predetermined sphere centred on the source, divided by the maximum amplitude modulus along the sphere. Thus the values thereof will lie between zero and one.

A directivity diagram corresponds to the intersection of the radiation diagram with a plane. It therefore characterises the variations in amplitude modulus on a circle of the plane centred on the source.

With reference to FIG. 3, the two opposite bottom electrodes 72A, 72B are aligned along an axis A1 passing through the centre of the piezoelectric ring 40. These two electrodes 72A, 72B form a first dipolar source of acoustic waves (vibrating dipole) radiating a minimal acoustic field, for example zero, along an axis A2 passing through the centre of the piezoelectric ring 40 and different from the axis A1, the acoustic field being antisymmetric with respect to this axis A2 (same absolute value, but opposite signs, that is to say phase opposition).

Thus, as illustrated in FIG. 4, the first dipolar source of acoustic waves in FIG. 3 has a first directivity diagram in the principal plane of the dermis 16 or of the plate 20, about the centre of the emission resonating disc 12, with a minimal value, zero in the example described, along the axis A2 passing through the centre of the emission resonating disc 12.

In the example described, the axis A2 is perpendicular to the axis A1. Preferably, the axes A1 and A2 are oriented in principal directions of the propagation medium 10.

In the example described, the directivity diagram of the first dipolar source of acoustic waves 72A, 72B has a butterfly shape with a zero value in the direction of the axis A2. For example, this first directivity diagram, denoted V1_{dir}, is equal to

$$V {1}_{dir} = \frac{\sqrt{{cos}^{2} α + {sin}^{2} 2 α}}{{max}_{α} \sqrt{{cos}^{2} α + {sin}^{2} 2 α}}$$

with α the angle expressed from the axis of A1.

With reference to FIG. 5, in the same way as the electrodes 72A, 72B, the two opposite bottom electrodes 74A, 74B are aligned along the axis A2 and form a second dipolar source of acoustic waves (vibrating dipole) radiation a zero acoustic field along the axis A1 and antisymmetric with respect to the axis A1 (same absolute value, but opposite signs, that is to say in phase opposition).

Thus, as illustrated in FIG. 6, the second dipolar source of acoustic waves in FIG. 5 has a second directivity diagram in the principal plane of the dermis 16 or of the plate 20, about the centre of the emission resonating disc 12, with a minimum value, zero in the example described, along the axis A1.

In the example described, the directivity diagram of the second dipolar source of acoustic waves 74A, 74B has a butterfly shape with a zero value in the direction of the axis A1. For example, this second directivity diagram, denoted V2_{dir}, is equal to

$$V {2}_{dir} = \frac{\sqrt{{sin}^{2} α + {sin}^{2} 2 α}}{{max}_{α} \sqrt{{sin}^{2} α + {sin}^{2} 2 α}} .$$

Thus the two aforementioned sources of acoustic waves are designed to emit, that is to say to radiate, bulk acoustic waves in the dermis 16 and in the plate 20 according to their respective directivity diagrams, the two directivity diagrams being concentric and different from each other.

The control signals E1 and E2 generate, by inverse piezoelectric effect, bulk acoustic waves in the dermis 16 and in the plate 20: in particular, antisymmetric Lamb waves characterised by two movement components in the plane of the plate 20 and outside the plane (perpendicular to the plane of the plate 20), propagate in the plate 20. The disturbance generated by a contact with the epidermis 26 affects in particular, by damping on the contact surface, the off-plane movement component.

In polar coordinates, the off-plane component of the acoustic field, denoted S₁, emitted by the first dipolar source of acoustic waves 72A, 72B, observed at a distance r from the centre of the emission resonating disc 12 and for an angle α, is similar to the control signal e₁(t) with in addition firstly a propagation delay

$$\frac{2 π}{λ} r .$$

where λ designates the wavelength of the acoustic waves, and secondly a weighting corresponding to the directivity diagram. In the example described, the control signal e₁(t) is sinusoidal in form e₁(t)=E₁₀ sin(2πft), so that the off-plane component S₁ is also sinusoidal and described by its components

$$\{ \begin{matrix}{S}_{1 x} \\ {S}_{1 y}\end{matrix} \}$$

in cartesian coordinates with respect to the axes A1 and A2:

$${S}_{1} ( t , r , α ) = \{ \begin{matrix}{S}_{1 x} \\ {S}_{1 y}\end{matrix} \} = \{ \begin{matrix}cos ( α ) \cdot {A}_{10} \cdot sin ( 2 π \cdot f \cdot t - \frac{2 π}{λ} r ) \\ sin ( 2 α ) \cdot {A}_{10} sin ( 2 π \cdot f \cdot t - \frac{2 π}{λ} r )\end{matrix} \} ,$$

where A₁₀ designates the peak amplitude of the off-plane component S₁, proportional to the peak amplitude of the control signal E₁₀.

In the same way, in the example described, the control signal e₂(t) is sinusoidal in form e₂(t)=E₂₀ sin(2πft), so that the off-plane component of the acoustic field, denoted S₂ due to the second dipolar source of acoustic waves 72A, 72B, is also sinusoidal and described by its components

$$\{ \begin{matrix}{S}_{2 x} \\ {S}_{2 y}\end{matrix} \}$$

in cartesian coordinates with respect to the axes A1 and A2:

$${S}_{2} ( t , r , α ) = \{ \begin{matrix}{S}_{2 x} \\ {S}_{2 y}\end{matrix} \} \{ \begin{matrix}sin ( 2 α ) {A}_{20} \cdot sin ( 2 π \cdot f \cdot t - \frac{2 π}{λ} r ) \\ sin ( α ) {A}_{20} \cdot sin ( 2 π \cdot f \cdot t - \frac{2 π}{λ} r )\end{matrix} \} ,$$

where A₂₀ designates the peak amplitude of the off-plane component S₂, proportional to the peak amplitude of the control signal E₂₀.

The off-plane movement components S₁ and S₂ of the acoustic fields both correspond to bending modes and are therefore sensitive to a contact, for example to that of a finger on the epidermis 26.

The program 56 is designed to weight the two control signals e₁(t) and e₂(t) and to vary this weighting over time. In the example described, the weighting is effected as follows: k·e₁(t) and (1−k)·e₂(t) with k varying between zero and one. This variation in weighting causes a corresponding variation in the amplitudes of the acoustic fields S₁ and S₂: A₁=k·A₀ and A₂=(1−k)·A₀, so that:

$${S}_{1} ( t , r , α ) = \{ \begin{matrix}{S}_{1 x} \\ {S}_{1 y}\end{matrix} \} = \{ \begin{matrix}k \cdot cos ( α ) {A}_{10} \cdot Sin ( 2 π \cdot f \cdot t - \frac{2 π}{λ} r ) \\ k \cdot sin ( 2 α ) {A}_{10} \cdot Sin ( 2 π \cdot f \cdot t - \frac{2 π}{λ} r )\end{matrix} \} , \\ and$$

$${S}_{2} ( t , r , α ) = \{ \begin{matrix}{S}_{2 x} \\ {S}_{2 y}\end{matrix} \} = \{ \begin{matrix}( 1 - k ) \cdot sin ( 2 α ) {A}_{20} \cdot Sin ( 2 π \cdot f \cdot t - \frac{2 π}{λ} r ) \\ ( 1 - k ) \cdot sin ( α ) {A}_{20} \cdot Sin ( 2 π \cdot f \cdot t - \frac{2 π}{λ} r )\end{matrix} \} .$$

The two dipolar sources of acoustic waves 72A, 72B and 74A, 74B are excited independently of each other, each of them generating a field characteristic of the geometry and orientation of the electrodes.

The excitation of bulk acoustic waves by inverse piezoelectric effect is a linear and invariant process, so that the off-plane component of the acoustic field generated by the emission resonating disc 12 in the plate 20 is equal to the sum of the off-plane components of the two sources:

$$S ( t , r , α ) = {S}_{1} ( t , r , α ) + {S}_{2} ( t , r , α ) = \{ \begin{matrix}{S}_{1 x} + {S}_{2 x} \\ {S}_{1 y} + {S}_{2 y}\end{matrix} \} ,$$

that is to say:

$$S ( t , r , α ) = \{ \begin{matrix}\begin{matrix}k \cdot cos ( α ) {A}_{10} \cdot sin ( 2 π \cdot f \cdot t - \frac{2 π}{λ} r ) + ( 1 - k ) \cdot sin ( 2 α ) {A}_{20} \cdot \\ sin ( 2 π \cdot f \cdot t - \frac{2 π}{λ} r - ϕ )\end{matrix} \\ \begin{matrix}k \cdot sin ( 2 α ) {A}_{10} \cdot sin ( 2 π \cdot f \cdot t - \frac{2 π}{λ} r ) + ( 1 - k ) \cdot sin ( α ) {A}_{20} \cdot \\ sin ( 2 π \cdot f \cdot t - \frac{2 π}{λ} r - ϕ )\end{matrix}\end{matrix} \}$$

The emission resonating disc 12 thus generates bulk acoustic waves the spatial amplitude distribution of which at any frequency f varies as a function of k in the plate 20. A similar reasoning may be conducted for the pressure waves propagating in the dermis 16. Thus, by generalising, it is deduced from this that the emission resonating disc 12 generates bulk acoustic waves the spatial amplitude distribution of which at any frequency f varies as a function of k in the propagation medium 10.

To illustrate this variation in the plate 20, in the case where the two sources of acoustic waves are controlled in phase with a zero phase difference φ and synchronously, that is to say at the same frequency, the aforementioned total off-plane component S can be expressed according to a modulus and a phase, that is to say, in complex notation:

$$\overline{S} ( t , r , α ) = \sqrt{\begin{matrix}{( k \cdot cos ( α ) \cdot {A}_{10} \cdot ( 1 - k ) \cdot sin ( 2 α ) \cdot {A}_{20} )}^{2} + \\ {( k \cdot sin ( 2 α ) {A}_{10} \cdot ( 1 - k ) \cdot sin ( α ) \cdot {A}_{20} )}^{2}\end{matrix}} \cdot {e}^{j ( 2 π \cdot f \cdot t - \frac{2 π}{λ} r )}$$

Thus the off-plane component of the acoustic field emitted in the plate 20, at the frequency f, by the emission resonating disc 12, is written in general terms: S(t, P, k)=A(P, k)·sin(2π·f·t−φ(P)), where P is a point on the epidermis 26 having as coordinates (r,α). This off-plane component has an amplitude distribution A(P,k) at the frequency f, which varies as a function of k. This means that, for two different values of k, the associated amplitude distributions are different and not proportional to each other.

To illustrate this variation in the amplitude distribution, various forms of the directivity diagram, according to the previous equations and where applicable obtained experimentally, of the emission resonating disc 12 according to various values of k are illustrated in FIGS. 7 to 11.

If the acoustic waves emitted are not monochromatic (that is to say at a single frequency) the Fourier theory comes down to the monochromatic case, by breaking down any signal into a sum of monochromatic signals.

With reference to FIG. 12, in the example described, the program 56 is designed to make k increase from zero to one out of forty levels and to make the frequency f decrease from one level to the following, from 100 kHz as far as 20 kHz. It is advantageous to make the frequencies decrease rather than the reverse, since the acoustic waves of high frequencies propagate more quickly that the acoustic waves of lower frequencies. Thus, by causing the frequencies to decrease, the first acoustic waves emitted being caught up by the following is prevented.

Thus the first control signal E1 is equal, for the level i (i ranging from one to forty) to: e₁(t)=kᵢ·A₀ sin(2πfᵢt), while the second control signal E2 is equal, for this same level i, to: e₂(t)=(1−kᵢ)·A₀ sin(2πfᵢt), with k₁=0, k₄₀=1 et f₁=100 kHz and f₄₀=20 kHz.

Preferably, each level lasts for an integer number of oscillation periods of the control signals E1 and E2. In total, the succession of emissions for k varying from zero to one lasts for less than 10 ms.

Thus, at each level, the emission resonating disc 12 emits an acoustic wave at the frequency f and with an amplitude distribution in the plate 20:

$$A ( P , {k}_{i} ) = \sqrt{\begin{matrix}{( k \cdot cos ( α ) \cdot {A}_{0} \cdot ( 1 - k ) \cdot sin ( 2 α ) \cdot {A}_{0} )}^{2} + \\ {( k \cdot sin ( 2 α ) {A}_{0} \cdot ( 1 - k ) \cdot sin ( α ) \cdot {A}_{0} )}^{2}\end{matrix}} .$$

Thus the amplitude spectrum of each acoustic wave i is non-zero for the single frequency fᵢ. The amplitude spectrum of each acoustic wave therefore has, at this frequency fᵢ, different in the example described from one acoustic wave emitted to another, an amplitude varying in the medium at a certain spatial distribution of amplitude A(P,kᵢ). By virtue of the variation of kᵢ one acoustic wave emitted to another, the spatial amplitude distributions A(P,kᵢ) of the acoustic waves emitted successively are different from one another.

FIG. 13 shows the propagation medium 10 in view from below. The emission resonating disc 12 is placed at a corner of the propagation medium 10, which is in this example rectangular in shape (the scale between the propagation medium 10 and the emission resonating disc 12 is not complied with, the latter being greatly enlarged for better visibility). In the reference frame of FIG. 13, it is placed in the top left-hand corner. It is oriented so that the axis A1 is parallel to the top edge and the axis A2 parallel to the left-hand edge of the propagation medium 10. The reception resonating disc 14 is placed at another corner of the medium 10, here the right-hand top corner. It is oriented so that its principal axis B has an angle of 45 degrees with the edges of the propagation medium 10.

A disturbance P, located at a distance r from the centre of the emission resonating disc 12 and at an angle α from the axis A1, has an influence on all the successive radiation diagrams resulting from the successive emissions previously described, in particular because of reflections generated on the waves emitted at the angle α and returned towards the reception resonating disc 14 at an angle β with the axis B, but also because of dampings or any blockages and diffractions. These radiation diagrams are disturbed in amplitude and phase. The result is a frequency signature specific to the location of the disturbance P with a submillimetric resolution for a contact surface of around one square centimetre (i.e. the pulp of an index finger). Moreover, the dermis 16 having a thickness and elasticity causing a local deformation of this thickness by the disturbance, the frequency signature is not only specific to the location of the disturbance P but also to the pressure that it exerts locally on the propagation medium 10 thus deformable. It should also be noted that a global damping of the reception signal R that is more or less great reveals a more or less great contact surface between the disturbance P and the propagation medium 10. The contact surface of the disturbance P can thus be evaluated. Finally, the disturbance has an influence on the radiation diagrams for as long as it persists so that it is also possible to evaluate its duration.

Optionally, the propagation medium 10 may also comprise a vibrating device M bonded to the plate 20 by means of an epoxy resin and then embedded in the dermis 16 for a vibrotactile feedback of the detection and location system. In FIG. 13, it is shown in the bottom left-hand corner of the propagation medium 10. This vibrating device M is chosen, among the vibrating devices known from the prior art, for generating a low-frequency mechanical vibration in the dermis 16, for example by means of an off-centre mass, less than 500 Hz and preferably even less than 200 Hz. It is for example a flat electromagnetic micromotor with an off-centre mass typically generating vibrations at 200 Hz at a DC excitation voltage of 3.6 V.

It is intended to fulfil at least one of the following two functions:
haptic feedback of the detection and location system in certain preprogrammed circumstances according to a strategy of exploration of the propagation medium 10 (validation of a recognised command, restitution of a force feedback, etc.),
accelerated homogenisation of the thickness of the dermis 16 after a disturbance that has deformed it in a significant and potentially lasting manner.

The second function may be fulfilled because the rotation of the off-centre mass in the principal plane of the flat micromotor presents a shearing effect with respect to the plate 20 while laterally compressing the dermis 16, which makes its thickness uniform and releases any residual stresses in the plate 20.

In order to fulfil the aforementioned two functions, a vibrotactile feedback will therefore preferentially be activated when a disturbance starts (for 130 ms for example) or after the end of a disturbance (for 200 ms for example).

According to one possible improvement, several vibrating devices M may be disposed at the periphery of the propagation medium 10 and function in a synchronised fashion in order to increase, by constructive effect, the amplitude of the low-frequency wave propagated in the dermis 16 at a required point on the touch surface formed by the propagation medium 10. In particular, if the disturbance is caused by the finger of a user, the required point may be just under the finger or just upstream of a path traced by the finger, so that the user has the impression of encountering an obstacle during a strategy of exploration of the touch surface in relation to an underlying graphical display delimiting for example the limits of a graphical object or a particular graphical relief.

A learning method for the detection, location and qualification of disturbances on the touch surface, implemented by the program 58, will now be detailed. This learning method takes advantage of the fact that any disturbance P has an influence on the successive radiation diagrams emitted by the emission resonating disc 12 and that this influence is specific to the location of the disturbance and the pressure that it exerts on the dermis 16.

As illustrated in FIG. 14, the propagation medium 10 forming a touch surface has a sensitive area 80 outside which the resonating discs 12, 14 and the vibrating device M are disposed.

As illustrated also in this figure and optionally, a heating element 82 is integrated in the dermis 16 (or bonded behind the plate 20) inside the sensitive area 80. It may take the form of a film or a resistive wire in a coil for diffusion of heat by Joule effect. It is slaved to one or more reference temperatures. For an application of the disturbance detection and location system to a humanoid robot skin, it may be slaved to a single constant temperature of 37° C. For a touch interface application in the cabin of a motor vehicle, it may be slaved to several temperatures such as 10° C., 37° C. or 45° C. depending on the ambient temperature. Thus it may be decided that, if the ambient temperature is below 0° C., the element is slaved to 10° C., if the ambient temperature exceeds 0° C., the heating element is slaved to 37° C. and, if the ambient temperature exceeds 30° C., the heating element is slaved to 45° C. If the ambient temperature exceeds 45° C., it is for example the air conditioning of the vehicle that will make the temperature of the sensitive area 80 fall again. In extreme cases, the heating element may be replaced by a Peltier module to provide cooling. The thresholds of passing 0° C. and 30° C. may be associated with a hysteresis of a few degrees Celsius.

The temperature slaving of the heating element 82 is conventional and easily obtained by pulse width modulation (PWM) using a PMOS or NMOS transistor. The dynamic range of the slaving may be high on start-up (for example around one minute in order to increase the temperature by around ten degrees Celsius), and then low (around one degree Celsius per minute) as soon as the set temperature has been reached.

A first advantage of this constant temperature slaving of the sensitive area 80 by means of the heating element 82 is to make the process of detection and location of disturbances implemented by the system more reliable and to simplify the corresponding learning method, in particular by reducing the size of the learning set. It will moreover be seen, with reference to FIG. 16, that another advantage of this slaving is to enable the system to proceed with a measurement of thermometric conductivity of an object causing a disturbance for a certain amount of time and over a certain surface area of the touch interface.

The learning method uses reference contacts C(i, j) the positions of which inside the sensitive area 80 are known to the computing device 46. These reference contacts C(i, j) are for example distributed over a grid along the axis A1 and A2, where the indices (i, j) indicate their position in the grid.

It is moreover possible to define a neighbourhood function V(C(i, j)) for determining the adjacent reference contacts of a given reference contact C(i, j). For example, in the case where the reference contacts are distributed over a rectangular grid like the one illustrated in FIG. 14, the adjacent reference contacts are the eight contacts surrounding the reference contact in question on the grid (“first ring”).

As illustrated in FIG. 15, the learning method comprises a first step 100 during which the detection and location system with touch surface 10 is placed in a quiet environment while the propagation medium forming the touch interface, in particular its epidermis 26, is free from any disturbance.

Under these conditions, during a step 102, the computing device 46, by execution of its program 56, supplies the control signals E1 and E2 as shown in FIG. 12, to the emission resonating disc 12. The latter then emits a succession of longitudinal pressure acoustic waves 30 in the dermis 16 and bending longitudinal acoustic waves 32 in the plate 20 for no more than 10 ms.

At the same time and in a synchronised fashion, during a step 104, the reception resonating disc 14 receives the acoustic waves 30, 32 after propagation thereof in the propagation medium 10 and supplies to the computing device 46 an off-load reception signal R corresponding to the acoustic waves received. The off-load reception signal R lasts as long as the successive emissions last. It is amplified and quantified over 12 signed bits.

During a step 106, the processor 50 of the computing device 46, by execution of the program 58, calculates an estimation of the amplitude of the Fourier transform of the off-load reception signal R=r(t), referred to as the off-load spectral amplitude R(f)=|fft(r(t))|. It is a case more precisely of an FFT (Fast Fourier Transform) calculated on 8192 samples (or at least 4096 or even 1024 samples) of the received signal. A filtering is carried out so as to use at this stage only the spectral components lying between 20 kHz and 100 kHz.

During a step 108, a reference contact C(i, j) with a predetermined surface area and at a given pressure p is applied to the epidermis 26 of the touch surface, still in a quiet environment.

During a step 110, with the reference contact C(i, j) applied, the computing device 46, by execution of its program 56, supplies the control signals E1 and E2 as shown in FIG. 12, to the emission resonating disc 12. The latter then emits pressure longitudinal acoustic waves 30 in the dermis 16 and bending longitudinal acoustic waves 32 in the plate 20 during a step 112.

At the same time and in a synchronised fashion, during a step 114, the reception resonating disc 14 receives the acoustic waves 30, 32 after their propagation in the propagation medium 10 and supplies to the computing device 46 a reference reception signal R_{i,j,p}=r_{i,j,p}(t) r for the position (i, j) and for the pressure p. The reference reception signal R_{i,j,p} lasts as long as the successive emissions last. It is amplified and quantised in 12 signed bits.

During a step 116, the processor 50 of the computing device 46, by execution of the program 58, calculates an estimation of the amplitude of the Fourier transform of the reference reception signal R_{i,j,p}=r_{i,j,p}(t), referred to as the referenced spectral amplitude R_{i,j,p}(f)=|fft(r_{i,j,p}(t))|. It is a case more precisely also of an FFT calculated on 8192 samples (or at least 4096 or even 1024 samples) of the received signal. A filtering is carried out so as to use at this stage only the spectral components lying between 20 kHz and 100 kHz.

During a step 118, the processor 50 of the computing device 46, by execution of the program 58, calculates a distance, referred to as the relative standardised distance of reference spectral amplitude DNR(i, j, p) between the off-load spectral amplitude and the reference spectral amplitude. For example, the relative standardised distance of reference spectral amplitude DNR(i, j, p) is equal to the norm 1 of the percentage variation of the off-load spectral amplitude R(f)=|fft(r(t))| and reference spectral amplitude R(f)=|fft(r_{i,j,p}(t)|:

$$DNR ( i , j , p ) = {\sum }_{f} \vert \frac{{R}_{i , j , p} ( f ) - R ( f )}{R ( f )} \vert = {\sum }_{f} \vert \frac{{R}_{i , j , p} ( f )}{R ( f )} - 1 \vert .$$

This relative standardised distance is very relevant for discriminating the reference contacts from each other, not only because of their respective positions but also for the various pressures that may be exerted on each of these reference contacts, by virtue of the elasticity in thickness of the dermis 16. It is recorded in the database 54 in order subsequently to be exploited in a detection, location and characterisation of disturbance.

The learning method then returns to step 108, for another pressure value on the reference contact in the course of learning or for a learning on another reference contact, until all the reference contacts and all the required pressures are scanned.

A method for detecting, locating and qualifying disturbances on the touch surface implemented by the program 60 will now be detailed with reference to FIG. 16. It comprises first of all the initialisation steps 200 to 210.

During a first step 200 the detection and location system with touch screen 10 is placed, free from any disturbance, in its utilisation environment, the latter being able to comprise a residual noise causing the propagation medium forming the touch surface 10 to vibrate and thus producing a stray signal in the reception signal R supplied by the reception resonating disc 14. The residual noise may also come from the processing electronics, in particular quantisation noise, of the system itself.

Under these conditions, during a step 202, the computing device 46, by execution of its program 56, supplies the control signals E1 and E2 as shown in FIG. 12, to the emission resonating disc 12. The latter then emits a succession of pressure longitudinal acoustic waves 30 in the dermis 16 and bending longitudinal acoustic waves 32 in the plate 20 for no more than 10 ms.

At the same time and in a synchronised fashion, during a step 204, the reception resonating disc 14 receives the acoustic waves 30, 32 after propagation thereof in the propagation medium 10 and supplies to the computing device 46 a reception signal, referred to as a reception signal with residual noise R_{BR}=r_{BR}(t), corresponding to the acoustic waves received. The reception signal with residual noise R_{BR} lasts as long as the successive emissions last. It is amplified and quantised in 12 signed bits.

During a step 206, the processor 50 of the computing device 46, by execution of the program 60, calculates an estimation of the amplitude of the Fourier transform of the reception signal with residual noise R_{BR}=r_{BR}(t), referred to as spectral amplitude with a residual noise R_{BR}(f)=|fft(r_{BR}(t))|. It is a case more precisely of an FFT calculated on 8192 samples (or at least 4096 or even 1024 samples) of the received signal. A filtering is performed so as to use at this stage only the spectral components lying between 20 kHz and 100 kHz.

During a following step 208, the processor 50 of the computing device 46 calculates a starting residual noise BRD from the spectral amplitude with residual noise R_{BR}(f) and the off-load spectral amplitude R(f). For example, the starting residual noise BRD is the norm 1 of the percentage variation of the spectral amplitudes with a residual noise R_{BR}(f) and of-load R(f):

$$BRD = {\sum }_{f} \vert \frac{{R}_{BR} ( f )}{R ( f )} - 1 \vert .$$

Next, during an end-of-initialisation step 210, the processor 50 of the computing device 46 initialises, to the value of the starting residual noise, a data item BR representing the current residual noise, that is to say the operation: BR←BRD

The initialisation steps are followed in particular by a monitoring step 212 during which any disturbance is detected and located, associated with a pressure value of the disturbance against the dermis 16.

Before continuing the description of the method for detecting, locating and qualifying disturbances in FIG. 16, this monitoring step 212 will now be detailed with reference to FIG. 17.

It starts with a step 300 during which a counter of iterations n is initialised to the value 1. The monitoring step 212 then comprises a step loop, the current iteration of this step loop being the iteration n.

During a first step 302 of this step loop, the computing device 46, by execution of its program 56, supplies the control signals E1 and E2 as shown in FIG. 12, to the emission resonating disc 12. The latter then emits a succession of pressure longitudinal acoustic waves 30 in the dermis 16 and bending longitudinal acoustic waves 32 in the plate 20 for no more than 10 ms.

At the same time and in a synchronised fashion, during a step 304, the reception resonating disc 14 receives the acoustic waves 30, 32 after propagation thereof in the propagation medium 10 and supplies to the computing device 46 a reception signal, referred to as the current reception signal Rₙ=rₙ(t), corresponding to the acoustic waves received. The current reception signal Rₙ=rₙ(t) lasts as long as the successive emissions last. It is amplified and quantised in 12 signed bits. Optionally and switchably, it may be high-pass filtered before amplification in order to prevent any saturation of the relevant signal to be processed. In particular, the cutoff frequency of such high-pass filtering is advantageously fixed at 160 Hz in order to eliminate any strong vibrations at very low frequency. The amplification may be performed by means of a variable-gain amplifier (from 1 to 50) thus adapting to the distance between the emission 12 and reception 14 resonating discs or to the elasticity of the dermis 16 and enabling the received signal to remain in linear mode in a range of +/−5 V.

During the following step 306, the processor 50 of the computing device 46, by execution of the program 60, calculates an estimation of the amplitude of the Fourier transform of the current reception signal Rₙ=rₙ(t), referred to as the current spectral amplitude Rₙ(f)=|fft(rₙ(t))|. It is a case more precisely of an FFT calculated on a 8192 samples (or at least 4096 or even 1024 samples) of the received signal.

This step is followed by a filtering step 308 so as to exploit only the spectral components lying between 20 kHz and 100 kHz. By eliminating the spectral components below 20 kHz, all the passive structure noises are eliminated such as the motor noises, the vibrotactile feedback vibrations, etc. Such an elimination of low frequencies could also be anticipated at step 304 but only in the case of a risk of saturation of the useful signal and impossibility, because of this saturation, of locating a disturbance: the received signal could then undergo a last amplification, for example adjustable from 1 to 10 in order to reach the full scale of its linear range after analogue to digital conversion. Furthermore, in the spectral band 20 kHz-100 kHz, a second filtering is performed consisting of eliminating the spectral components that have an amplitude below 1% of the spectral component of highest amplitude and/or to clip all the spectral components where the relative variation with respect to the absence of contact is greater than a given threshold value, for example 100%. This makes it possible to prevent the spectral components of low amplitude but high relative variation, often unstable to temperature variations, masking the information contained in the spectral components of high amplitude but lower relative variation.

During a step 310, the processor 50 of the computing device 46, by execution of the program 60, calculates a distance, referred to as the current spectral amplitude relative standardised distance DNRₙ, between the spectral amplitude with residual noise R_{BR}(f) and the current spectral amplitude Rₙ(f). For example, the reference spectral amplitude relative standardised distance DNRₙ is equal to the norm 1 of the percentage variation of the spectral amplitude with residual noise R_{BR}(f) and current spectral amplitude Rₙ(f):

$${DNR}_{n} = {\sum }_{f} \vert \frac{{R}_{n} ( f )}{{R}_{BR} ( f )} - 1 \vert .$$

During a step 312, the processor 50 of the computing device 46, by execution of the program 60, calculates a current disturbance PCₙ from the current spectral amplitude relative standardised distance DNRₙ and the residual noise BR. For example, the current disturbance PCₙ is the percentage variation between the current spectral amplitude relative standardised distance DNRₙ and the residual noise BR:

$${PC}_{n} = \vert \frac{{DNR}_{n}}{BR} - 1 \vert \times 100.$$

During a step 314, the processor 50 of the computing device 46, by execution of the program 60, tests whether the current disturbance PCₙ has drifted slightly with respect to the previous iteration, which indicates a variation in the residual noise, but not a disturbance since the latter would give rise to a great variation in the current disturbance PCₙ. Such a small drift is for example detected if:

$$\vert \frac{{PC}_{n}}{{PC}_{n - 1}} - 1 \vert \times 100 \leq 15 \%$$

If a small drift in current disturbance PCₙ is detected, steps 316, 318 and 320 are implemented.

During step 316, the processor 50 of the computing device 46, by execution of the program 60, updates the spectral amplitude with residual noise R_{BR}(f) to the value of the current spectral amplitude Rₙ(f), that is to say the operation: R_{BR}(f)←Rₙ(f).

During the following step 318, the processor 50 computes the new residual noise BR from the spectral amplitude with residual noise R_{BR}(f) updated, that is to say:

$$BR = {\sum }_{f} \vert \frac{{R}_{BR} ( f )}{R ( f )} - 1 \vert .$$

Finally, during step 320, the processor 50 increments n by one unit and the method returns to steps 302 and 304.

If no small drift in current disturbance PCₙ is detected, during a step 322, the processor 50 of the computing device 46, by execution of the program 60, determines whether the current disturbance PCₙ is high, for example above a predetermined threshold, which would indicate the occurrence of a disturbance. For example, a disturbance P is detected if: PCₙ≧100%.

If no disturbance is detected (PCₙ<100%), then an end of loop step 340 is passed to during which the iteration counter n is incremented by one unit and the monitoring step 212 returns to steps 302 and 304.

If a disturbance P is detected, during a step 324, the processor 50 of the computing device 46, by execution of the program 60, calculates the differences between the current spectral amplitude relative standardised distance DNRₙ and all the reference spectral amplitude relative standardised distances DNR(i, j, p). In the example described, these differences are expressed in percentages of the residual noise. Still in the example described, these differences are placed in a cubic matrix ENRDₙ(i, j, p) where each element (i, j, p) of the cubic matrix corresponds to the difference with respect to the reference contact C(i, j) at the pressure p:

$${ENRD}_{n} ( i , j , p ) = \vert \frac{{DNR}_{n} - DNR ( i , j , p )}{BR} - 1 \vert \times 100.$$

During a step 326, the processor 50 determines the reference contact C(i, j) associated with a pressure p closest to the disturbance P detected. It is a case of the reference contact associated with the smallest element of the matrix ENRDₙ(i, j, p) (that is to say the element indicating the smallest difference with respect to the current spectral amplitude relative standardised distance DNRₙ). This smallest element is denoted ESₙ=ENRD(iₙ, jₙ, pₙ), with (iₙ, jₙ, pₙ) its position in the cubic matrix ENRDₙ(i, j, p).

In a simple variant of the invention, the processor 50 supplies, as the position of the detected disturbance P, the position of the closest reference contact C(iₙ, jₙ) and, as the pressure exerted against the elastic dermis 16, the value pₙ. The monitoring step 212 then passes to the end of the loop step 340.

However, in the exampled described, the position of the detected disturbance P is refined.

Thus, during a step 328, the processor 50 of the computing device 46, by execution of the program 60, tests whether the disturbance P detected is close or not to the closest reference contact C(iₙ, jₙ) of pressure pₙ, by means of a proximity condition.

To this end, in the example described, this determination is made by calculating a contrast ratio RCₙ between the smallest element ESₙ and the other elements of the cubic matrix ENRDₙ(i, j, p). For example, the contrast ratio RCₙ is calculated by

$${RC}_{n} = \frac{{〈 {ENRD}_{n} ( i , j , p ) 〉}_{i , j , p}}{{ES}_{n}} \times 100 ,$$

where the brackets < > designate the calculation of mean. Then the processor 50 determines whether the detected disturbance P is close or not to the closest reference contact C(iₙ, jₙ) of pressure pₙ from the contrast ratio RCₙ. In the example described, the disturbance P detected is close to the closest reference contact C(iₙ, jₙ) of pressure pₙ if the contrast ratio is greater than a predetermined value, for example if RCₙ≧150.

In a variant, the contrast ratio RCₙ, necessarily greater than 100, can be expressed in the form of a confidence index ICₙ that takes it between 0 and 100 (0 for a minimum confidence and 100 for maximum confidence):

$${IC}_{n} = ( 1 - \frac{100}{{RC}_{n}} ) \times 100.$$

RCₙ≧150 then corresponds to ICₙ≧33,33.

During a step 330, if the disturbance P detected has been determined as close to the reference contact C(iₙ, jₙ) of pressure pₙ (i.e. RCₙ≧150 at step 328), then the processor 50 supplies, as the position of the detected disturbance P, the position of the closest reference contact C(iₙ, jₙ) and, as the pressure exerted against the elastic dermis 16, the value of pₙ. The monitoring step then passes to the end-of-loop step 340.

During a step 332, if the disturbance P detected has not been determined as close to the closest reference contact C(iₙ, jₙ) of pressure pₙ (i.e. RCₙ<150 at step 328), then the processor 50 of the computing device 46, by execution of the program 60, determines the position of the disturbance P from the positions of the closest reference contact C(iₙ, jₙ) and of its adjacent reference contacts, according to the neighbourhood function V(C(iₙ, jₙ)) defined previously with reference to FIG. 14.

More precisely, during a step 334, the processor 50 calculates an equivalent mass Mₙ(i, j) for each element of the matrix ENRDₙ(i, j, pₙ) extracted from the cubic matrix ENRDₙ(i, j, p), the equivalent mass Mₙ(i, j) being higher, the lower this element (inverse function or equivalent), which corresponds to a difference with respect to the current spectral amplitude relative standardised distance DNRₙ. In the example described, the equivalent mass Mₙ(i, j) is calculated by:

$${M}_{n} ( i , j ) = \frac{{ES}_{n}}{{ENRD}_{n} ( i , j , {p}_{n} )} .$$

During a step 336, the processor 50 calculates the barycentre of the reference contacts C(i, j) weighted by their corresponding equivalent mass, situated in the neighbourhood V(C(iₙ, jₙ)) around the closest reference contact C(iₙ, jₙ).

Finally, during a step 338, the processor 50 supplies, as the position of the detected disturbance P, the barycentre thus calculated. It supplies as the exerted pressure value the value pₙ found at step 326. The monitoring step 212 then passes to the end-of-loop step 340.

It will be noted that, during the monitoring 212, the control signals E1 and E2 are for example emitted with a period lying between a few Hz and 50 Hz and that the FFT calculations are for example performed continuously on an acquisition window of 8192 samples at a sampling frequency of 0.7 M-samples/s (i.e. approximately 85 Hz) with quantisation of the signal in 12 bits.

It will also be noted that, when the detection and location system is in particular designed to detect and locate the touch of a finger, the pitch of the reference contact grid is preferably less than or equal to the characteristic dimension of a finger. To give an order of magnitude, the contact surface of an index finger is approximately 1.3 cm² and the characteristic dimension of the touch is approximately 12 mm. Thus the pitch of the grid is preferably less than 1 cm, for example equal to 6 mm. Furthermore the reference contacts of the learning have a characteristic dimension similar to that of a finger. Thus, by virtue of the previous grid pitch, these reference contacts overlap one another. This makes it possible to have a reduced number of reference contacts while offering a high resolution, less than 1 mm, by means of the calculation of the barycentre. This also makes it possible to reduce the position recognition errors when the touch slides slowly and continuously from one reference contact to another. The fact that there is partial overlap of the reference contacts thus guarantees that a touch is more finely located. Reliability is also increased since a touch is detected not with respect to a single reference contact, but with respect to several reference contacts situated in the same neighbourhood. The overlap of two adjacent reference contacts must thus be sufficient for the disturbances to be fairly similar and for the calculation of the barycentre to have a meaning. In other words, the grid pitch must be sufficiently fine with respect to the characteristic dimension of the finger so that the random placing of the finger on the touch area always sufficiently covers a reference contact. It is thus guaranteed that the contrast level threshold is always reached during a touch, in particular when the touch occurs at the middle of two reference contacts. The grid pitch must however remain as large as possible in order not to unnecessarily increase the number of reference contacts and therefore the duration of the learning.

Moreover, if the grid pitch is much smaller than the characteristic radius of the touch, the neighbourhood area may be extended to a second or third reference contact ring. The number of rings is for example equal to the characteristic radius divided by the grid pitch. For a grid pitch of 3 mm, two reference contact rings will for example be taken.

In an improvement, the position refined by means of the calculation of the barycentre can then be adjusted to a grid with a high resolution. The position and movement of the finger are thus measured fairly finely on this higher-resolution grid. For example, the grid of the reference contacts may have a pitch of 6 mm, while the high-resolution grid may be that of a graphical display screen having typically a pitch of 0.3 mm. Thus, in the case of a high-definition screen comprising 1920×1080 pixels at a pitch of 0.3 mm, i.e. 576×324 mm (66 cm or 26 inches diagonal), the reference contact grid is reduced, with respect to the high-resolution grid, to 97×55 that is to say 5335 dots, i.e. a reduction by a factor of almost 400 while keeping a fine adjustment of the touch of the high-resolution grid.

Moreover, the method for refining the location of a detected disturbance may be further improved. This is because the method of FIG. 17 has the drawback that the barycentre as calculated has a tendency to be situated close to the closest reference contact, even when the disturbance detected is situated very “off centre” from the closest reference contact, that is to say almost halfway with an adjacent reference contact.

To overcome this problem, the method of FIG. 17 can be improved in order to overweight the reference contacts adjacent to the closest reference contact. This makes it possible to move the location of the detected disturbance off centre with respect to the closest reference contact, and thus to correctly locate the disturbances occurring halfway between two reference contacts. To amplify the effect, it is also possible to define the equivalent masses from the square, cube or a higher power of the differences ENRDₙ(i, j, pₙ).

Another way of improving the location as far as halfway between two adjacent reference contacts consists of determining the position of the detected disturbance from a non-linear function of the sigmoid or hyperbolic tangent type of the barycentre with respect to the position of the closest reference contact. Such a function makes it possible to amplify the small distances of the barycentre with respect to the closest reference contact, while limiting the position of the disturbance detected halfway. It will thus be possible to take:

$$\{ \begin{matrix}{X}_{HD} = {X}_{zi} + \frac{1}{2} Tanh ( a ( {X}_{g} - {X}_{Zi} ) ) \\ {Y}_{HD} = {Y}_{zi} + \frac{1}{2} Tanh ( a ( {Y}_{g} - {Y}_{Zi} ) ) ,\end{matrix}$$

where X_{HD}, Y_{HD} are the coordinates of the detected disturbance, X_{zi}, Y_{zi}, the coordinates of the closest reference contact, X_{g}, Y_{g} the coordinates of the barycentre and a the amplification factor of the movement, which may typically be between 5 and 10.

Let us now return to a continuation of the description of the method for detection, location and qualification of disturbances illustrated in FIG. 16. The monitoring step 212 detailed above supplies, at each instant n (i.e. every 20 ms for an emission frequency of the waves E1 and E2 of 50 Hz) a detection or absence of detection of disturbance. This detection is optionally accompanied by location values (iₙ, jₙ) of the disturbance on the touch surface 10 and of pressure pₙ exerted by this disturbance against the dermis 16.

It should be noted that the monitoring step 212 has been detailed for the detection and location of a single disturbance, that is to say with a single locatable contact. However, it can easily be adapted to detect and locate a multiple disturbance, that is to say with at least two locatable contacts, each of these contacts exerting a pressure that is particular to it. In particular, when the disturbance is a single and multiple touch with a finger, its influence on the successive radiation diagrams of the waves E1 and E2 is low and additive, so that it is possible to enhance the learning unit by linear combinations of the single disturbances learnt. The reason for this additivity property is as follows: in the case where the radiation diagram has slow spatial variation, that is to say, in the Fourier space, associated with spatial frequencies lower than those of a finger or the disturbance, which is the case with a dipolar radiation, the disturbance is proportional to the contact surface. This is all the more true when the disturbance of the volume waves is overall lower and the disturbance by viscous damping, a non-linear phenomenon dependent on the vibration speed, is lower. Then there remains only the disturbance related to the phenomenon of diffraction of the waves, the received field diffracted by the multiple interaction or interactions being, according to the Huygens-Fresnel principle, the Kirchhoff-Sommerfeld integral applied to the interaction surface or surfaces. However, the Huygens-Fresnel principle means that each interaction area behaves like a distribution of secondary source points. The diffracted total field for a multiple contact is then indeed the sum of the diffracted fields for punctiform contacts.

In parallel to the monitoring step 212 and following the initialisation steps 200-210, a step 214 of estimating damping of the acoustic waves emitted E1 and E2 in the propagation medium 10 is executed. This damping is estimated for example by comparison of the FFTs calculated and filtered between 20 kHz and 100 kHz during the initialisation steps and the monitoring step, or more precisely by comparison, by means of a ratio, of the norm of the current spectral amplitude Rₙ(f) calculated and filtered at steps 306 and 308 with the norm of the spectral amplitude with residual noise R_{BR}(f) calculated and filtered at step 206 or updated during an execution of step 316. It can be simply expressed as a percentage and calculated, at each instant n, once the step 308 of the current iteration has been executed. This damping, then denoted Aₙ, is proportional to the contact surface between the detected disturbance and the epidermis 26. It therefore makes it possible to distinguish a single touch of the finger from an extensive surface contact.

In parallel to the monitoring step 212 and following the initialisation steps 200-210, a step 216 of processing acoustic low frequencies is executed. This step may also be executed at each iteration n, after calculation 306 of the current spectral amplitude Rₙ(f) but before filtering 308 thereof. This is because, during this step 216, only the components of the current spectral amplitude Rₙ(f) lower than 20 kHz are kept and processed, in particular those relating to the audible spectrum lying between 100 Hz and 15 kHz. The richness of the audible frequencies makes it possible to distinguish a disturbance by scraping or caress, specific to the chosen texture of the epidermis 26, from a simple vibration of the dermis 16 subjected to external vibrations.

Several parameters can be estimated during this step: passing of a threshold value of the norm of a vector consisting of a number of predetermined frequency components chosen between 100 Hz and 20 kHz, calculation of a frequency barycentre applied to a range of frequencies, for example the range of frequencies lying between 100 Hz and 5 kHz, etc.

In particular, the frequency barycentre Fg applied between a frequency fmin and a frequency fmax of the current spectral amplitude Rₙ(f) is given by the following formula:

$$Fg = \frac{{\sum }_{fi = f min}^{f max} fi \times {R}_{n} ( fi )}{{\sum }_{fi = f min}^{f max} {R}_{n} ( fi )} .$$

In parallel to the monitoring step 212 and following initialisation steps 200-210, a step 218 of processing acoustic high frequencies is executed. This step may also be executed at each iteration n, after calculation 306 of the current spectral amplitude Rₙ(f) but before filtering 308 thereof. This is because, during this step 218, only the components of the current spectral amplitude Rₙ(f) above 100 kHz are kept and processed. The appearance of frequencies above 100 kHz (for example 160 kHz) beyond a certain threshold may in fact reveal an impact or electrical problems. A selective filter may on this occasion be used, for example a selective filter at 160 kHz with programmable gain from 1 to 16. The programmable gain makes it possible to adjust the sensitivity of the touch surface to impacts and electrical problems. For example, if the touch surface is that of a humanoid robot, this may be made more or less sensitive depending on the context: robot at rest (maximum sensitivity), in movement (reduced sensitivity), etc.

Such a detection of frequencies above 100 kHz may optionally trigger a step 220 of asynchronous acquisition of acoustic signals, this asynchronous acquisition step temporarily stopping any emission of the control signals E1 and E2. The asynchronous acquisition is next characterised according to its frequency content, in particular below 20 kHz. During an asynchronous acquisition triggering in the middle of an emission of control signals E1, E2, there remains transient vibratory energy by reverberation in the dermis 16. The spectral characterisation of a disturbance such as an impact or electrical problem is therefore done outside the 20 kHz-100 kHz spectrum. In a variant, another method could consist of not stopping the emissions of the control signals E1 and E2 during the asynchronous acquisition 220, but simply subtracting from the detected signal the offload reception signal offset in time by the difference that there is between the asynchronous acquisition instant and the normal instant of synchronous acquisition. The norm of the detected signal and its spectral distribution below 20 kHz (in particular its frequency barycentre) respectively qualify the intensity and nature of an impact. Moreover, the absence of an audible signal below 20 kHz is then characteristic of electrical problems.

In parallel to the monitoring step 212 and following the initialisation steps 200-210, a step 222 of measuring heat transfers is executed. This step may also be executed at each iteration n, after the calculation 306 and the filtering 308 of the current spectral amplitude Rₙ(f) by using for example the latter to detect therein any frequency shift over time.

A first method consists of calculating the frequency barycentre of the current spectral amplitude Rₙ(f) in the range lying between 20 kHz and 100 kHz. A shift of the frequency barycentre towards the low frequencies represents a heating of the dermis 16 and plate 20 and therefore a contact with a warmer object, while a shift towards the high frequencies represents the converse. Such a shift is preferably noted before or after a disturbance, but not while this is being exerted since, during a touch interaction, disturbances by damping and diffraction mask this thermal phenomenon.

A variant of this first method consists of calculating the position of a local extremum of the current spectral amplitude Rₙ(f) corresponding to a particular resonant frequency of the propagation medium 10 of the detection and location system. In this case, it is even possible to carry out a specific frequency sweep around this resonant frequency, for example between 39 kHz and 41 kHz if the resonance is situated at 40 kHz. A high-resolution FFT calculation in this specific range then affords a precise detection of the position of the local extremum, optionally involving a quadratic interpolation of the FFT about the extremum. As with the frequency barycentre, a shift of the local extremum towards the low frequencies represents a heating of the dermis 16 and plate 20 and therefore a contact with a warmer object, while a shift towards the high frequencies represents the converse.

The frequency shift of the local extremum may moreover be noted without passing through an FFT calculation but by a simple measurement of peak amplitude of the signal received by the resonating disc 14 in around ten predefined frequencies around the approximate position of the extremum and then by quadratic interpolation. This calculation is simpler and quicker than an FFT calculation. It may also be applied for calculating the frequency barycentre only over around ten predefined frequencies.

A second method consists of calculating the Euclidian norm of the current spectral amplitude Rₙ(f) in the range lying between 20 kHz and 100 kHz. A variation in one direction, for example upwards, of this norm represents a change in temperature of the dermis 16 and plate 20 and therefore a contact with an object having a different temperature, for example warmer, while a variation in the other direction represents the converse. The direction of variation of the norm according to the temperature is not known at the start, it depends on the excitation signal as much as on the touch material chosen, its form, its dimensions or the location of the transducers (resonating discs 12 and 14). Such a variation in norm must be noted off load, that is to say before or after a disturbance but not while this is being exerted since, during a touch interaction, the disturbances by damping and diffraction mask this thermal phenomenon.

A third method consists of measuring a particular zero crossing of the acoustic signal R received by the reception resonating disc 14, in particular a zero crossing of the highest excitation frequency in the range lying between 20 kHz and 100 kHz, that is to say around 100 kHz. A shift of this zero crossing towards the origin of the emission time for the control signals E1 and E2 represents a cooling of the dermis 16 and plate 20 and therefore a contact with a colder object, while a shift in the other direction represents the converse. Likewise, such a shift is preferably noted before or after a disturbance but not while this is being exerted since, during a touch interaction, disturbances by damping and diffraction mask this thermal phenomenon.

The zero crossing is detected by means of a fast comparator activated only at the moment of the arrival on the reception resonating disc 14 of the head of a wave packet. The observation frequency may also correspond to a resonant frequency of the emission resonating disc 12 so that any variation in temperature related to a transfer of heat produces an effect on the transit time (of around a few ns/° C. for a distance of a few centimetres) of the acoustic wave propagating from the emission resonating disc 12 to the reception resonating disc 14 through the dermis 16 and plate 20.

A fourth, non-acoustic, method consists of providing at least one temperature sensor, for example a thermistor, in the dermis 16. This method however depends greatly on the location of the sensor with respect to the heat transfer area. However, it has the advantage of giving access to a heat measurement in real time, that is to say before, during or after a disturbance. It therefore combines well with at least one of the previous three methods.

It should be noted that the aforementioned four methods may provide slaving of the heating element 82 when the latter is provided in the detection and location system according to the invention. Furthermore, by combining the possibilities of measuring the duration of a disturbance, by means of the successive results supplied by the monitoring step 212, the contact surface of this disturbance, by means of the step 214, and the heat transfers caused by this disturbance, by means of step 222, it is possible to derive therefrom a measurement of the effusivity of the material which, in contact with the touch surface 10, caused this disturbance. This characteristic of the disturbance as well as others will now be dealt with during a characterising step 224 which, by means of decision parameters and rules predefined in the database 54, takes a decision on the type of disturbance detected, on the basis of the results supplied by steps 212 to 222.

During this step 224, a first set of rules makes it possible to characterise a single or multiple touch by means of a finger for example. It makes it possible in particular to distinguish it from a disturbance such as a contact with a garment when the touch interface is the skin of a humanoid robot.

This first set of rules is for example as follows:
if a disturbance is detected for a period D greater than a minimum threshold period (D_min=50 ms for example) during the monitoring step 212,
if this disturbance is located (i, j) reliably (index PCn greater than 100% throughout the period D),
if the damping An measured during step 214 is approximately stable and low (a few percentage points) during the period D,
if the pressure p estimated during the monitoring step 212 remains greater than a predetermined threshold value p_min during the period D,
if no particular noise is perceived below 20 kHz (step 216) or above 100 kHz (step 218),
   then the disturbance P detected is a single or multiple touch (depending on the number of locations returned by the monitoring step 212).

According to this same first set of rules, if everything is verified except for the condition of p greater than p_min, and if optionally slight audible noises are received at step 216, then the disturbance P is an artefact due for example to a fabric (garment of a humanoid robot) in contact with the epidermis and causing slight frictions perceptible locally. The system can then take into account this artefact in order to update the value of the current residual noise BR.

According to this same first set of rules, if everything is verified except for the location of the disturbance and the duration D of the disturbance exceeds a predetermined maximum threshold duration D_max, then the disturbance P is a parasitic touch of the adhesive, dirt or other type. The system can then take into account this parasitic touch in order to update the value of the current residual noise BR.

According to this same first set of rules, if the pressure p estimated during the monitoring step 212 increases gradually during the period D, the disturbance P is referred to as pressure and may cause the generation of a suitable response, anthropomorphic (audio feedback, movement of the robot carrying the touch surface, etc) or not (luminous signal, vibrotactile feedback of frequency proportional to the pressure p exerted by means of the vibrating device M, etc). From a mechanical point of view, by means of this increase in pressure, the change is gradually from a situation where the acoustic waves propagate freely in the dermis 16 to a situation where they are blocked and no longer pass through the area where the dermis 16 is deformed by compression, which is equivalent to a gradual diffraction effect under an increasing load impedance. A simple finger contact at a slight pressure not causing any crushing of the dermis 16 causes a first current disturbance level PCₙ while a pressure p responsible for crushing of the dermis 16 is characterised by a second current disturbance level PCₙ.

According to this first set of rules, if the pressure p exceeds a threshold value p_max predefined as a pain threshold, the disturbance is termed aggressive pressure and may justify the generation of a suitable response aimed at protecting the detection and location system.

According to this first set of rules, the characterisation of a touch may be refined if, during learning, not only the pressure causing a normal deformation of the dermis 16 but also the effect of a force tangential to the surface of the epidermis 26 is characterised specifically by its acoustic signature. This is because the monitoring step is capable in this case of returning not only the location and the normal pressure exerted by the disturbance, but also shearing parameters (direction and intensity) of this disturbance.

The shearing is the fact of a touch interaction with a force and an oblique deformation. The deformation of the dermis 16 is then associated with a bead in the direction of the force, downstream of the contact area, and a negative pressure upstream of the contact area. The characterisation of a shearing by learning is suited to small touch surfaces such as a touch surface equipping the end of a robot finger or a virtual touch button disposed on a larger touch surface, but having locally (for example over 1 cm²) a richer functionalisation, in order for example to enable the orientation of a rear-view mirror or the movement of a cursor on a graphic screen according to the direction of the shear force imposed by a finger, the speed of movement of the rear-view mirror or of the cursor being able to be proportional to the intensity of the total disturbance recorded.

During step 224 also, a second set of rules makes it possible to detect and characterise a contact the surface of which is extensive.

This second set of rules is for example as follows:
if a disturbance is detected during a period D greater than a minimum threshold period (D_min=50 ms for example) during the monitoring step 212,
if this disturbance is not located reliably and precisely, marked by a low confidence index IC,
if the damping An measured during step 214 is high during the period D, in particular greater than 10%, characteristic of a large contact surface and proportional to the latter,
if no particular noise is perceived below 20 kHz (step 216) or above 100 kHz (step 218),
   then the disturbance P detected is a surface contact (a hand flat against the epidermis 26 for example).

According to this same second set of rules, if in addition a heat transfer measurement is made before and after the disturbance (step 222 and according to any one of the four methods cited) and indicates an effective transfer of heat, while the dermis 16 is slaved to a given temperature, then the surface contact can be characterised more finely. By quantifying the thermal exchanges by means of threshold values predefined in the database 54, it is thus possible initially to classify the surface contact in several categories, for example three:
“cold” surface contact, if a drop in temperature is measured by means of one of the four methods proposed beyond a first threshold,
“hot” surface contact, if an increase in temperature is measured by means of one of the four methods proposed beyond a second threshold,
“neutral” surface contact, if a variation in temperature is measured by means of one of the four methods proposed between the first and second thresholds.

Pain thresholds according to sensitivity to hot and cold may be defined, with optional triggering of a reaction, anthropomorphic or not.

Secondly, by standardising the thermal difference measured by the duration D of the disturbance and its surface (step 214), it also becomes possible to classify the surface contact in several other categories, for example three:
surface contact with a high-effusivity material such as metal, if the standardised difference is greater in absolute value than a first predetermined high threshold,
surface contact with a low-effusivity material such as cork or polystyrene foams, if the standardised difference is lower in absolute value than a second predetermined low threshold, and
surface contact with a medium effusivity material, if the standardised difference lies in absolute value between the two predetermined thresholds.

A prior calibration may make it possible, according to the inherent effusivity of the touch surface 10, to correlate the “high effusivity”, “medium effusivity” and “low effusivity” categories with reference materials, such as metal for the “high effusivity” category, polymethyl methacrylate or wood for the “medium effusivity” category and cork or polystyrene foams for the “low effusivity” category.

According to this same second set of rules, if the duration D of the surface contact is less than another predetermined threshold duration, for example 500 ms, then the disturbance is termed pulse type.

According to this same second set of rules, if the damping Aₙ measured during step 214 is not only high during the period D, in particular higher than 10%, but also gradually increasing until it exceeds a second damping threshold such as 30%, then the disturbance is termed thrust.

According to the same second set of rules, if all the conditions are satisfied except the last, that is to say if an audible noise is perceived below 20 kHz (step 216) and this noise is specific to the chosen texture of the epidermis 26, then the disturbance is termed a caress. The specificity of the audible noise may be characterised by means for example of a frequency barycentre or the norm of a vector with several frequency components over a range of frequencies chosen between 100 Hz and 20 kHz. If furthermore a movement of the disturbance is detected (variable location on a path in a certain direction), depending on the speed of the movement and the intensity of the audible noise, the caress may be specified as a light caress (slow movement, low audible noise), rapid (rapid movement, audible noise with higher frequency components, in particular above 5 kHz), or very rapid and termed sweeping (very rapid movement, audible noise with higher frequency components, in particular above 5 kHz and acoustic frequencies perceived beyond 100 kHz for at least 50 ms).

During step 224 equally, a third set of rules makes it possible to detect and characterise a disturbance of the scraping type.

This third set of rules is for example as follows:
if the disturbance is not detected sufficiently precisely to be termed touch or surface contact,
if an audible noise is perceived below 20 kHz (step 216) and this noise is specific to the chosen texture of the epidermis 26, then the detected disturbance P is a scraping.

The estimation of the frequency barycentre between 100 Hz and 5 kHz also makes it possible to distinguish a scraping from a simple vibration of the environment in which the detection and location system is situated or to characterise the environment in which the detected scraping occurs.

During step 224 equally, a fourth set of rules makes it possible to detect and characterise a disturbance of the impact/cracking type.

This fourth set of rules is for example as follows:
if a disturbance is detected during a period D less than the minimum threshold period D_min=50 ms during the monitoring step 212,
if this disturbance is not located (i, j) reliably (index PCₙ remaining close to 100%),
if the damping An measured during step 214 is small during the period D,
if acoustic frequencies are perceived below 20 kHz (step 216) and above 100 kHz (step 218),
if the asynchronous acquisition step 220 is triggered and audible acoustic frequencies are perceived below 20 kHz,
   then the disturbance P detected is an impact with a small hard object.

The impact may be characterised even more precisely by studying the value of the estimated frequency barycentre in a range chosen in the audible frequencies. The more the frequency barycentre is offset towards high frequencies, while remaining in the audible frequencies, the sharper the impact and the more it is associated with a small object.

According to this same fourth set of rules, if the asynchronous acquisition step 220 is triggered and no audible frequency is perceived below 20 kHz, then the disturbance is due to electrical problems generating an electromagnetic noise. If this noise persists, the system for detecting and locating disturbances may temporarily deactivate the reception and processing of the frequencies external to the 20 kHz-100 kHz emission range.

According to this same fourth set of rules, if all the conditions are satisfied with the exception of the triggering of the asynchronous acquisition step 220 and the period D is close to or exceeds by no more than 100 ms the minimum threshold period D_min, then the disturbance is a tap. It is more precisely a sharp tap, compatible with a touch location if acoustic frequencies between 10 kHz and 20 kHz are generated above a certain threshold for no more than 100 ms, or a strong tap, difficult to locate if acoustic frequencies between 500 Hz and 10 kHz are generated above a certain threshold for no more than 150 ms.

The detection of taps may be associated with a tap counter if such disturbances are reproduced several times in a predetermined period of time, but remain clearly separable from one another (unlike a scraping).

During step 224 also, a fifth set of rules makes it possible to detect and characterise a disturbance of the vibration type. This fifth set of rules has for example a single rule: if a certain number of predetermined frequencies below 500 Hz exceeds a certain threshold, then vibrations are detected.

Finally, a tactile confusion or itching may be detected if a disturbance is detected that is not recognised by the previous sets of rules and last beyond a predefined period. This triggers for example an alert signal as well as optionally the activation of a vibrotactile feedback by means of the vibrating device M in order to attempt to make the thickness of the dermis 16 uniform. If the disturbance persists, an assistance may be made necessary and the disturbance is then recognised as a tactile aggression.

It is clear that the detection and location system previously described makes it possible, in particular by means of the steps of monitoring 212, estimation of damping and therefore of contact surface 214, processing of acoustic low frequencies 216, processing acoustic high frequencies 218, asynchronous acquisition 220 optionally triggered by step 218 and measurement of heat transfers 222, to detect, locate and characterise finely a large number of disturbances of very diverse types. As has been seen, it is thus possible to discriminate single or multiple touches with or without shearing, pressures, painful or not, surface contacts, caresses, scrapings, impacts, sharp or strong taps, or parasitic touches, and to integrate them in order to be able to detect other disturbances, disturbances due to the presence of a garment, and to integrate them in order to be able to detect other disturbances, vibrations, mechanical shakes, electrical disturbances, hot or cold contacts, with materials of low, medium or high effusivity, etc.

It should be noted however that, although a particular example of functioning of the monitoring step 212 has been detailed in relation to a particular functioning of the learning method as illustrated in FIG. 15, the invention could be implemented with another detection and location method by acoustic monitoring, associated with another corresponding learning method and other means of emitting/receiving bulk acoustic waves, such as for example one of the methods described in the patents or patent applications published under the numbers FR 2 916 545, FR 2 948 471 and FR 2 948 787.

Likewise, the method for characterising disturbances used at step 224, the use of a textured epidermis, the presence of at least one vibrating device for a vibrotactile feedback, steps 216 and 218/220 of processing acoustic frequencies other than those emitted by the system, the method for measuring heat transfer, or even for measuring effusivity (in the presence of a heating element), used at step 222, are independent of the invention in that, although they afford an advantageous improvement to it, they could be implemented in a detection and location system such as one of those described in the patents or patent applications published under the numbers FR 2 916 545, FR 2 948 471 and FR 2 948 787, not providing any elastic dermis with a thickness locally deformable by a disturbance.

According to another embodiment of the invention, the system for detecting and locating a disturbance P illustrated schematically in section in FIG. 18 differs from the one in FIG. 1 in that the medium 10′ for propagating bulk acoustic waves comprises principally a support 20′, for example a rigid shell made from plastics material, having locally a recess in which an elastic dermis 16′ is inserted having the same characteristics in terms of material used as the dermis 16 (for example a resin or a silicone gel), but with very much reduced dimensions. The dimensions of the recess, that is to say those of the surface occupied by the dermis 16′, are around a few centimetres at most, that is to say a surface area occupied by the dermis of a few square centimetres at most. In this case, the dermis 16′ fulfils a function of mechanical button that may, by virtue of the detection method described previously, be sensitive to the pressure of a touch and to the shearing forces exerted.

To protect the dermis 16′ from a direct contact liable to damage it, the epidermis 26 may be replaced by a cover 26′ with lateral dimensions less than those of the recess for insertion thereof in the latter and partial immersion in the dermis 16′. The cover 26′ is for example made from plastics or metal material. It has a bottom the rim of which extends in a cylinder towards the inside of the recess. The free end of the cylindrical rim is provided with a collar. The collar extends towards the outside of the cylinder as illustrated in FIG. 18, but could also extend towards the inside of the cylinder. The collar and a bottom part of the cylindrical rim of the cover 26′ are immersed in the dermis 16′, while the bottom of the cover projects on the surface of the dermis 16′ and of the support 20′. The interior of the cover 26′ is moreover filled by the dermis 16′. It is therefore the combination of the dermis 16′ and of its cover 26′ that forms a button sensitive to pressures and shearings and the function of which may then be multiple, the cover 26′ constituting a shell floating on the dermis 16′.

According to various possible embodiments, the cover 26′ may have a flat or curved bottom, optionally itself deformable under pressure, for example according to a travel-force law with a locally negative slope of the monostable type. In all cases, a pressure by a user on the cover 26′ deforms the dermis 16′ in thickness, which disturbs the propagation of the pressure waves 30 in the propagation medium 10′ and more precisely in the dermis 16′. By application of the method previously detailed, the actuated button is located and the type of actuation (duration, pressure, shearing, etc) is recognised.

The advantage of such a button with a floating cover locally disposed in the support 20′ is to standardise and make universal, that is to say understandable to a large number of users, the actuation of a particular area of the propagation medium of the detection and location system according to the invention. It will also be understood that the advantage of such a button with a floating cover is to be able to make robust certain regularly stressed areas while keeping a tactile perception on the rest of the propagation medium 10′.

However, more generally, according to a particular embodiment of the invention, the elastic dermis 16 or 16′ may be located, with or without cover or epidermis, in order to simply functionalise certain particular areas of the propagation medium of the detection and location system, since the electronics for emitting, receiving and processing signals received may be offset without difficulty in another area of the system. Various applications of functionalisations of areas comprise for example the end of a finger of a humanoid robot, the top of its head, elements protecting its body, certain areas of toy shells, etc. It is moreover in this context that the optional presence of a heating element 82 integrated in the dermis 16 or 16′ is the most relevant, that is to say on a reduced surface area and optionally for a limited time, when the functionalised area is activated according to certain predefined circumstances. In this way the consumption generated by such element is limited.

The applications of a system for detecting and locating disturbances such as the one described previously are many. They comprise touch interfaces for the automobile industry (window winders, rear view mirror orientation device, car-radio buttons, air conditioning, access to the bonnet, etc), the design of artificial skins (dermis and epidermis) for humanoid robots sensitive to various types of contact including through garments, ergonomic keyboards with flexible keys, computer mice, toys, force sensors, emotion sensors by perception of exchanges of heat with a shell gripped in the palm of a robot hand, etc.

It should also be noted that the invention is not limited to the embodiments described previously. It will be clear in fact to a person skilled in the art that various modifications can be made to the embodiments described above in the light of the teaching that has just been disclosed to him.

In particular, the different spatial distributions from one wave to another in the method for emitting acoustic waves previously described could be phase spatial distributions, in place of or in addition to amplitude spatial distributions. In particular, the various types of control signals described previously (change in the contribution of the two sources and change in the phase difference between the two sources) give rise to phase spatial distributions that are different from one wave to another.

Furthermore, the control signals could be not monochromatic, but have on the contrary an extended spectrum. Thus the acoustic waves emitted (in a solid or in air, depending on the embodiment) would also have an extended spectrum. In this case, the emission device would be designed so that the spectra of the acoustic waves have, each at at least a certain frequency, respective spatial distributions of amplitude or phase that are different from each other. For example, the spatial distributions change for all the frequencies, from one acoustic wave to another.

In the following claims, the terms used must not be interpreted as limiting the claims to the embodiments disclosed in the present invention, but must be interpreted in order to include therein all the equivalents that the claims aim to cover because of the formulation thereof and the prediction of which is within the capability of a person skilled in the art applying his general knowledge to the implementation of the teaching that has just been disclosed to him.

1-13. (canceled)

14. A system for detecting and locating a disturbance of a medium, comprising:
a medium for propagating bulk acoustic waves;
means for emitting bulk acoustic waves in the medium;
means for receiving the bulk acoustic waves after propagation thereof in the medium, and configured to supply a reception signal from the acoustic waves received; and
means for detecting and locating the disturbance in the medium from the reception signal;
wherein the medium comprises a dermis layer of elastic material with a thickness locally deformable by the disturbance.

15. The system for detecting and locating a disturbance of a medium as claimed in claim 14, wherein the Young's modulus characteristic of elasticity of the dermis is between 0.1 and 10 Mpa.

16. The system for detecting and locating a disturbance of a medium as claimed in claim 14, wherein the dermis includes a polymer, gel, or silicone resin and has a thickness at rest of between 0.5 and 5 mm, or of 2 mm.

17. The system for detecting and locating a disturbance of a medium as claimed in claim 14, wherein the bulk acoustic waves emitted in the medium comprise pressure waves propagating in the dermis.

18. The system for detecting and locating a disturbance of a medium as claimed in claim 14, wherein the medium comprises a supplementary epidermis layer tensioned against an external surface of the dermis and with a texture such that a contact with friction on the epidermis generates a spectrum of acoustic vibrations in audible frequencies detectable by the means for receiving bulk acoustic waves.

19. The system for detecting and locating a disturbance of a medium as claimed in claim 14, wherein the dermis layer is disposed in a recess in a rigid support of the system and protected by a cover, or a cover made from plastics or metal material, with lateral dimensions less than those of the recess for insertion thereof in the recess and partial immersion thereof in the dermis.

20. The system for detecting and locating a disturbance of a medium as claimed in claim 14, further comprising a vibrating device embedded in the dermis for a vibrotactile feedback controlled according to mechanical vibrations with a frequency less than 500 Hz in the dermis, or less than 200 Hz.

21. The system for detecting and locating a disturbance of a medium as claimed in claim 14, wherein:
the means for emitting bulk acoustic waves comprises at least one resonating disc emitting in a predetermined emission frequency range, outside the audible frequency range of 50 Hz to 15 kHz; and
the means for receiving bulk acoustic waves comprises at least one resonating disc receiving in a frequency range including at least the predetermined emission frequency range and the audible frequency range.

22. The system for detecting and locating a disturbance of a medium as claimed in claim 21, wherein the predetermined emission frequency range is in a range of 20 kHz-100 kHz.

23. The system for detecting and locating a disturbance of a medium as claimed in claim 14, further comprising:
means for estimating a detected disturbance duration; and
means for measuring a heat transfer from or to the propagation medium during the disturbance duration.

24. The system for detecting and locating a disturbance of a medium as claimed in claim 23, further comprising:
means for slaving temperature of at least part of the propagation medium to at least one predetermined slaving temperature; and
means for estimating effusivity of a disturbing object from the slaving temperature and the heat transfer measurement.

25. The system for detecting and locating a disturbance of a medium as claimed in claim 11, further comprising:
means for measuring a damping, due to presence of disturbance, of the bulk acoustic waves propagating in the medium; and
means for estimating contact surface area of the disturbance from the damping measurement.

26. The system for detecting and locating a disturbance of a medium as claimed in claim 14, wherein:
the emission means is configured to emit successive acoustic waves in the medium;
the reception means is configured to receive the successive acoustic waves after propagation thereof in the medium, and
the emission means is configured such that, amplitude and/or phase spectrum of each acoustic wave having, at at least a certain frequency, an amplitude and/or respectively a phase varying in the medium according to a certain amplitude and/or respectively phase spatial distribution, the amplitude and/or respectively phase spatial distributions of the successive acoustic waves are different from each other.
